(19) United States
(12) Patent Application Publication
(10) Pub. No.: US 2016/0037421 A1
(43) Pub. Date: Feb. 4, 2016

(54) HANDOVER OF MOBILITY MANAGEMENT ENTITY FOR LOAD BALANCING

(71) Applicant: NOKIA SOLUTIONS AND NETWORKS OY, Espoo (FI)

(72) Inventors: Joanna Pauliina JOKINEN, Espoo (FI); Juergen MAYER, Blaustein (DE); Henri Mikael POIKONEN, Helsinki (FI)

(21) Appl. No.: 14/773,652

(22) PCT Filed: May 15, 2013
(86) PCT No.: PCT/EP2013/060020

§ 371 Date: Sep. 8, 2015

(30) Foreign Application Priority Data
Mar. 7, 2013 (EP) PCT/EP2013/054557

(51) Int. Cl. H04W 36/22; H04W 28/08

(52) U.S. Cl. CPC H04W 36/22; H04W 28/08; H04W 88/08

(57) ABSTRACT

There is provided a mechanism for executing a handover for a subscriber between mobility management entities for load balancing reasons. A current mobility management entity sends (S10) a handover trigger message to a communication network control element like an eNB for indicating a relocation to the current cell and tracking area of the subscriber. The eNB starts (S20) a handover procedure to itself and sends (S30) a handover required message to the current mobility measurement entity. The current mobility measurement entity continues a handover procedure of a connection for the at least one subscriber from the current mobility management entity to a new mobility management entity, wherein the new mobility management entity is selectable (S40) at the current mobility management entity. The handover procedure can be modified in comparison to a default handover procedure by modifying and/or omitting handover related signaling. After the handover is completed, the new mobility management entity initiates (S60) a location update at a home subscriber server and reallocates the subscriber's UE a new temporary identity and a tracking area list.

### BACKGROUND OF THE INVENTION

1. Field of the Invention

The present invention relates to a mechanism for executing a handover for a subscriber between mobility management entities for load balancing reasons. Specifically, the present invention is related to an apparatus, a method and a computer program product which allow, for example, a handover from a current mobility management entity to a new mobility management entity due to load balancing reasons.

2. Related Background Art

Prior art which is related to this technical field can e.g. be found in technical specifications according to 3GPP TS 23.401 (e.g. version 11.4.0), TS 36.413 (e.g. version 11.2.1), and TS 36.300 (e.g. version 11.4.0).

The following meanings for the abbreviations used in this specification apply:

AP: application protocol

BS: base station

CN: core network

CPU: central processing unit

DNS: domain name system

eNB: evolved node B

EPC: evolved packet core

EPS: evolved packet system

E-UTRAN: evolved UTRAN

GUTI: globally unique temporary identity

HFN: hyper frame number

HO: handover

HSS: home subscriber server

IMSI: international mobile subscription identity

LTE: Long Term Evolution

LTE-A: LTE Advanced

MME: mobility management entity

NAS: non-access stratum

O&M: operation and maintenance

PDCP: packet data convergence protocol

PDN: packet data network

PGW: packet data network gateway

RNC: radio network controller

SGW: serving gateway

TA: tracking area

TAI: tracking area identity

TAU: tracking area update

TEID: tunnel endpoint identifier

UE: user equipment

UMTS: Universal Mobile Telecommunication Services

UTRA: UMTS terrestrial radio access

UTRAN: UMTS terrestrial radio access network

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) and fourth generation (4G) communication networks like the Universal Mobile Telecommunications System (UMTS), enhanced communication networks based e.g. on LTE or LTE-A, cellular 2nd generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication network and access environments.

Generally, for properly establishing and handling a communication connection between terminal devices such as a user equipment (UE) and another communication network element or user equipment, a database, a server, etc., one or more intermediate network elements such as communication network control elements, e.g. base stations or eNBs, core network elements, e.g. control nodes, support nodes and service nodes are involved which may belong to different communication network.

Wireless or cellular communication networks, such as 2G, 3G, LTE or LTE-A based networks, are divided in several sub-systems, for example an access network subsystem like UTRAN or E-UTRAN (evolved UTRAN), a core network subsystem (like EPC), etc. While the access network subsystem is mainly responsible for communicating with subscriber terminals or UEs via a wireless connection, the core network subsystem is responsible for overall control of the UEs and the establishment of bearers. The core network subsystem comprises several elements, such as gateways (SGW, PGW), mobility control elements or MME etc.

The MME, for example, is used as a control node for processing the signaling between the UE and the core network. It has functions related to bearer management (establishment, maintenance and release of bearers), connection management and inter-working with other networks. Furthermore, functions related to localizing and management of UEs being in an idle mode are done by the MME. For this purpose, an MME manages all UEs being located in a so called tracking area, wherein each tracking area may consist of one or more cells controlled by a corresponding communication network control element (e.g. an eNB). It is to be noted that a cell may belong to one or more tracking areas. Generally, when a UE enters or changes a tracking area, it conducts a TAU procedure so that the MME is aware of the tracking area where the UE is reachable. If plural MMEs are available for a cell, these MMEs form a MME pool.

In order to support O&M functions related to the communication network system, network management functions are provided. For example, load balancing and load re-balancing mechanisms between different MMEs are used. For example, MME load balancing functionality permits UEs entering into an MME pool area to be directed to an appropriate MME in a manner that achieves load balancing between the MMEs (e.g. by using a weight factor for each MME being set according to a capacity/load of the respective MME). Load re-balancing between MMEs, on the other hand, is used to permit UEs that are registered on one MME (within an MME pool) to be moved to another MME, which is used e.g. in connection with O&M related processes. It is to be noted that in case of load re-balancing all or a part of the UEs (subscribers) attached to the MME can be moved to the other MME.

However, when executing the present load re-balancing procedures, it is possible that a user experience is interrupted since certain services are caused when a UE is moved to a new (target) MME including a TAU procedure (without making handover prior to the TAU) so that a user plane needs to be released for a short period, as resources have not been pre-allocated on the target radio node prior to the new registration. Furthermore, the selection of the target MME relies on the mechanisms like load balancing (e.g. weight factor) which may not lead to an optimal overall selection result inside the MME pool. Also the currently standardized method does not provide means for the load balancing TAU triggering MME to select a specific target MME.

### SUMMARY OF THE INVENTION

It is an object of the invention to overcome at least some of the above described problems and to provide an enhanced mechanism for executing a handover for a subscriber between mobility management entities for load balancing reasons. Specifically, it is an object of the present invention to provide an improved apparatus, method, and computer program product which allow, for example, a handover from a current mobility management entity to a new mobility management entity due to load balancing reasons while a user experience is not affected.

These objects are achieved by the measures defined in the attached claims.

According to an example of an embodiment of the proposed solution, there is provided, for example, an apparatus comprising at least one processor, and at least one memory for storing instructions to be executed by the processor, wherein the at least one memory and the instructions are configured to, with the at least one processor, cause the apparatus at least to perform: a handover trigger receiving and processing function configured to receive and process a handover trigger message indicating that a change of at least one subscriber attachment from a current mobility management entity to a new mobility management entity is to be executed while a current cell and tracking area of the at least one subscriber is kept unchanged, a handover initiating function configured to initiate a handover of a connection for the at least one subscriber from the current mobility management entity to a new mobility management entity while maintaining the current cell and tracking area of the at least one subscriber, and a handover requirement indicating function configured to create a handover required message and cause transmission of the handover required message to the current mobility management entity, the handover required message indicating a requirement of a relocation of the at least one subscriber to the current cell and tracking area.

Furthermore, according to an example of an embodiment of the proposed solution, there is provided, for example, a method comprising receiving and processing a handover trigger message indicating that a change of at least one subscriber attachment from a current mobility management entity to a new mobility management entity is to be executed while a current cell and tracking area of the at least one subscriber is kept unchanged, initiating a handover of a connection for the at least one subscriber from the current mobility management entity to a new mobility management entity while maintaining the current cell and tracking area of the at least one subscriber, creating a handover required message for indicating a requirement of a relocation of the at least one subscriber to the current cell and tracking area, and causing transmission of the handover required message to the current mobility management entity.

According to further refinements, these examples may comprise one or more of the following features:
the handover trigger message may be received from the current mobility management entity;
the handover trigger message may comprise a first specific cause code indicating that the change of the at least one subscriber attachment from the current mobility management entity is due to a load balancing process;
for maintaining the current cell and tracking area of the at least one subscriber, a handover procedure for the at least one subscriber to the same cell to which the subscriber is currently attached may be started;
the handover required message may comprise a second specific cause code indicating that the requirement of the relocation of the at least one subscriber to the current cell and tracking area is due to a command from a core network element;
a handover procedure may be executed by communicating with the current mobility management entity and a new mobility management entity for completing the handover of the connection for the at least one subscriber from the current mobility management entity to the new mobility management entity while maintaining the current cell and tracking area of the at least one subscriber by indicating the current cell and tracking area as a target cell and target tracking area of the handover;
a type of a handover procedure to be executed may be determined being a default handover procedure or a special handover procedure in which a change from a current mobility management entity to a new mobility management entity is to be executed while a current cell and tracking area of the at least one subscriber is kept unchanged, and when it is determined that the type of the handover procedure to be executed is the special handover procedure, a configuration of the handover procedure to be executed may be modified from a default setting to a modified setting being different to the default setting;
the determination of the type of the handover procedure to be conducted may be based on an indication received in the handover trigger message;
the modification of the configuration of the handover procedure to be executed from the default setting to the modified setting may comprise at least one of: modifying a content of at least one signaling sent in the handover procedure by at least one of adding, amending and omitting of at least one parameter or at least one value comprised in a corresponding signaling sent in the default handover procedure, accepting and processing a modified content in at least one signaling received in the handover procedure, the modified content being changed in comparison to a content received in the default handover procedure by at least one of adding, amending and omitting of at least one parameter or at least one value comprised therein, skipping at least one signaling being sent in the default handover procedure, and accepting skipping of at least one signaling being received in the default handover procedure, and using data being internally stored instead of the at least one skipped signaling;
the above described measures may be implemented in a communication network control element comprising at least one of a base station, an access node or an evolved Node B of a cellular communication network, wherein the communication network control element may be configured to control a communication with at least one of a terminal device or user equipment of the at least one subscriber.

In addition, according to an example of an embodiment of the proposed solution, there is provided, for example, an apparatus comprising at least one processor, and at least one memory for storing instructions to be executed by the processor, wherein the at least one memory and the instructions are configured to, with the at least one processor, cause the apparatus at least to perform: a handover trigger function configured to create a handover trigger message and to cause transmission of the handover trigger message, the handover trigger message indicating that a change of at least one subscriber attachment from a current mobility management entity to a new mobility management entity is to be executed while a current cell and tracking area of the at least one subscriber is kept unchanged, a handover required message processing function configured to receive and process a handover required message, the handover required message indicating a requirement of a relocation of the at least one subscriber to the current cell and tracking area, and a handover processing function configured to continue a handover procedure of a connection for the at least one subscriber from the current mobility management entity to a new mobility management entity.

In addition, according to an example of an embodiment of the proposed solution, there is provided, for example, a method comprising creating a handover trigger message indicating that a change of at least one subscriber attachment from a current mobility management entity to a new mobility management entity is to be executed while a current cell and tracking area of the at least one subscriber is kept unchanged, causing transmission of the handover trigger message, receiving and processing a handover required message, the handover required message indicating a requirement of a relocation of the at least one subscriber to the current cell and tracking area, and continuing a handover procedure of a connection for the at least one subscriber from the current mobility management entity to a new mobility management entity.

According to further refinements, these examples may comprise one or more of the following features:
the handover trigger message may comprise a first specific cause code indicating that the change of the at least one subscriber attachment from the current mobility management entity is due to a load balancing process;
a command for initiating the change of at least one subscriber attachment from a current mobility management entity to a new mobility management entity may be received from at least one of a network operator or an operation and maintenance element and then processed, wherein the handover trigger message may be created and transmitted in reaction of a receipt of the command, wherein the command may further comprise an indication of an identity of a mobility management entity to be used as the new mobility management entity;
the new mobility management entity to which the handover of the connection for the at least one subscriber from the current mobility management entity is to be continued may be selected, wherein the handover procedure of the connection may be continued to the selected mobility management entity;
the new mobility management entity may be selected on the basis of one of an internal selection algorithm, and an indication of an identity of a mobility management entity to be used as the new mobility management entity received from at least one of a network operator or an operation and maintenance element;
the handover required message may comprise a second specific cause code indicating that the requirement of the relocation of the at least one subscriber attachment to the current cell and tracking area is due to a command from a core network element;
a handover procedure may be continued by communicating with a communication network control element to which the at least one subscriber is attached and the new mobility management entity for continuing the handover of the connection for the at least one subscriber from the current mobility management entity to the new mobility management entity while maintaining the current cell and tracking area of the at least one subscriber by using the current cell and tracking area as a target cell and target tracking area of the handover;
a type of a handover procedure to be continued may be determined being a default handover procedure or a special handover procedure in which a change from a current mobility management entity to a new mobility management entity is to be executed while a current cell and tracking area of the at least one subscriber is kept unchanged, and when it is determined that the type of the handover procedure to be continued is the special handover procedure, a configuration of the handover procedure to be continued may be modified from a default setting to a modified setting being different to the default setting;
the determination of the type of the handover procedure to be continued may be based on an indication received in the handover required message;
the modification of the configuration of the handover procedure to be continued from the default setting to the modified setting may comprise at least one of modifying a content of at least one signaling sent in the handover procedure by at least one of adding, amending and omitting of at least one parameter or at least one value comprised in a corresponding signaling sent in the default handover procedure, accepting and processing a modified content in at least one signaling received in the handover procedure, the modified content being changed in comparison to a content received in the default handover procedure by at least one of adding, amending and omitting of at least one parameter or at least one value comprised therein, skipping at least one signaling being sent in the default handover procedure, and accepting skipping of at least one signaling being received in the default handover procedure, and using data being internally stored instead of the at least one skipped signaling;
the above measures may be implemented in a mobility management entity acting as the current mobility management entity, wherein the subscriber may be attached to a cell controlled by a communication network control element comprising at least one of a base station, an access node or an evolved Node B of a cellular communication network, wherein the communication network control element may be configured to control a communication with at least one of a terminal device or user equipment of the at least one subscriber.

Moreover, according to an example of an embodiment of the proposed solution, there is provided, for example, an apparatus comprising at least one processor, and at least one memory for storing instructions to be executed by the processor, wherein the at least one memory and the instructions are configured to, with the at least one processor, cause the apparatus at least to perform: a handover function configured to execute a handover procedure for changing at least one subscriber attachment to a new mobility management entity while a current cell and tracking area of the at least one subscriber is kept unchanged, a home subscriber server updating function configured to conduct an update procedure for the at least one subscriber with a home subscriber server of the at least one subscriber when the handover procedure is completed, and a temporary identity reallocating function configured to conduct a reallocation procedure of a temporary identity of the at least one subscriber with a communication element of the at least one subscriber.

Moreover, according to an example of an embodiment of the proposed solution, there is provided, for example, a method comprising executing a handover procedure for changing at least one subscriber attachment to a new mobility management entity while a current cell and tracking area of the at least one subscriber is kept unchanged, conducting an update procedure for the at least one subscriber with a home subscriber server of the at least one subscriber when the handover procedure is completed, and conducting a reallocation procedure of a temporary identity of the at least one subscriber with a communication element of the at least one subscriber.

According to further refinements, these examples may comprise one or more of the following features:
when conducting the handover procedure, a second specific cause code indicating that the handover procedure is due to a command from a core network element may be received and processed;
a transmission of an update location request message may be caused for informing the home subscriber server of the at least one subscriber about the change to the new mobility management entity, and an update location acknowledgement message for completing the update procedure may be received and processed;
the temporary identity may be a global unique temporary identity, wherein a transmission of a global unique temporary identity reallocation command message to the communication element of the at least one subscriber may be caused for reallocating a global unique temporary identity and a tracking area list of the at least one subscriber, and a global unique temporary identity reallocation complete message may be received and processed for completing the reallocation procedure;
a type of a handover procedure to be executed may be determined being a default handover procedure or a special handover procedure in which a change from a current mobility management entity to a new mobility management entity is to be executed while a current cell and tracking area of the at least one subscriber is kept unchanged, and when it is determined that the type of the handover procedure to be executed is the special handover procedure, a configuration of the handover procedure to be executed may be modified from a default setting to a modified setting being different to the default setting;
the determination of the type of the handover procedure to be executed may be based on an indication received in the handover procedure;
the modification of the configuration of the handover procedure to be executed from the default setting to the modified setting may comprise at least one of modifying a content of at least one signaling sent in the handover procedure by at least one of adding, amending and omitting of at least one parameter or at least one value comprised in a corresponding signaling sent in the default handover procedure, accepting and processing a modified content in at least one signaling received in the handover procedure, the modified content being changed in comparison to a content received in the default handover procedure by at least one of adding, amending and omitting of at least one parameter or at least one value comprised therein, skipping at least one signaling being sent in the default handover procedure, and accepting skipping of at least one signaling being received in the default handover procedure, and using data being internally stored instead of the at least one skipped signaling;
the above described measures may be implemented in a mobility management entity acting as the new mobility management entity, wherein the subscriber may be attached to a cell controlled by a communication network control element comprising at least one of a base station, an access node or an evolved Node B of a cellular communication network, wherein the communication network control element may be configured to control a communication with at least one of a terminal device or user equipment of the at least one subscriber.

In addition, according to examples of the proposed solution, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

By virtue of the proposed solutions, it is possible to provide an enhanced mechanism for executing a handover for a subscriber between mobility management entities for load balancing reasons. Specifically, according to some examples of embodiments of the invention, it is possible to conduct a new type of load balancing handover allowing to provide a seamless mobility to the users. That is, it is possible to avoid a break in the user data flow (which may caused for example by conventional load balancing TAU procedure without a handover) and to provide a seamless mobility. Furthermore, it is possible for the current or old MME to trigger a handover to a new MME, wherein it may also influence the selection of a specific target MME. In addition, a configuration of a handover procedure for offloading purposes may be flexible so that, for example, a signalling load at the network can be adjusted and reduced. Moreover, the handover procedure can be executed transparently for a UE so that service impact can be avoided.

The above and still further objects, features and advantages of the invention will become more apparent upon referring to the description and the accompanying drawings.

### BRIEF DESCRIPTION OF THE DRAWINGS

FIG. 1 shows a diagram illustrating a communication network configuration where some examples of embodiments of the invention are implemented.

FIG. 2 shows a signaling diagram illustrating a procedure of a handover procedure according to an example of an embodiment of the invention.

FIG. 3 shows a flowchart illustrating a processing executed in a communication network control element in a handover procedure according to an example of an embodiment of the invention.

FIG. 4 shows a flowchart illustrating a processing executed in a mobility management entity in a handover procedure according to an example of an embodiment of the invention.

FIG. 5 shows a block circuit diagram of a communication network control element including processing portions conducting functions according to examples of embodiments of the invention.

FIG. 6 shows a block circuit diagram of a mobility management entity including processing portions conducting functions according to examples of embodiments of the invention.

FIG. 7 shows a flowchart illustrating a processing executed in a mobility management entity in a handover procedure according to an example of an embodiment of the invention.

FIG. 8 shows a block circuit diagram of a mobility management entity including processing portions conducting functions according to examples of embodiments of the invention.

FIG. 9 to FIG. 11 show a signaling diagram illustrating a handover procedure according to some examples of embodiments of the invention.

### DESCRIPTION OF PREFERRED EMBODIMENTS

In the following, examples and embodiments of the present invention are described with reference to the drawings. For illustrating the present invention, the examples and embodiments will be described in connection with a cellular communication network based on a LTE or LTE-A based communication system. However, it is to be noted that the present invention is not limited to an application using such types of communication system, but is also applicable in other types of communication systems and the like, for example an UMTS based communication system.

A basic system architecture of a communication network where examples of embodiments of the invention are applicable may comprise a commonly known architecture of one or more communication systems comprising a wired or wireless access network subsystem and a core network. Such an architecture may comprise one or more access network control elements, radio access network elements, access service network gateways or base transceiver stations, such as a base station, an eNB etc., which control a coverage area also referred to as a cell and with which one or more communication elements or terminal devices such as a UE or another device having a similar function, such as a modem chipset, a chip, a module etc., which can also be part of a UE or attached as a separate element to a UE, or the like, are capable to communicate via one or more channels for transmitting several types of data. Furthermore, core network elements such as gateway network elements, policy and charging control network elements, mobility management entities and the like are part of the communication network.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from a communication element or terminal device like a UE and a communication network, besides those described in detail herein below.

Furthermore, the described network elements, such as communication network control elements, like an BS, an eNB and the like, core network elements like an MME, an SGW and the like, as well as corresponding functions as described herein may be implemented by software, e.g. by a computer program product for a computer, and/or by hardware. In any case, for executing their respective functions, correspondingly used devices, nodes or network elements may comprise several means and components (not shown) which are required for control, processing and communication/signaling functionality. Such means may comprise, for example, one or more processor units including one or more processing portions for executing instructions, programs and for processing data, memory means for storing instructions, programs and data, for serving as a work area of the processor or processing portion and the like (e.g. ROM, RAM, EEPROM, and the like), input means for inputting data and instructions by software (e.g. floppy disc, CD-ROM, EEPROM, and the like), user interface means for providing monitor and manipulation possibilities to a user (e.g. a screen, a keyboard and the like), interface means for establishing links and/or connections under the control of the processor unit or portion (e.g. wired and wireless interface means, an antenna, etc.) and the like. It is to be noted that in the present specification processing portions should not be only considered to represent physical portions of one or more processors, but may also be considered as a logical division of the referred processing tasks performed by one or more processors.

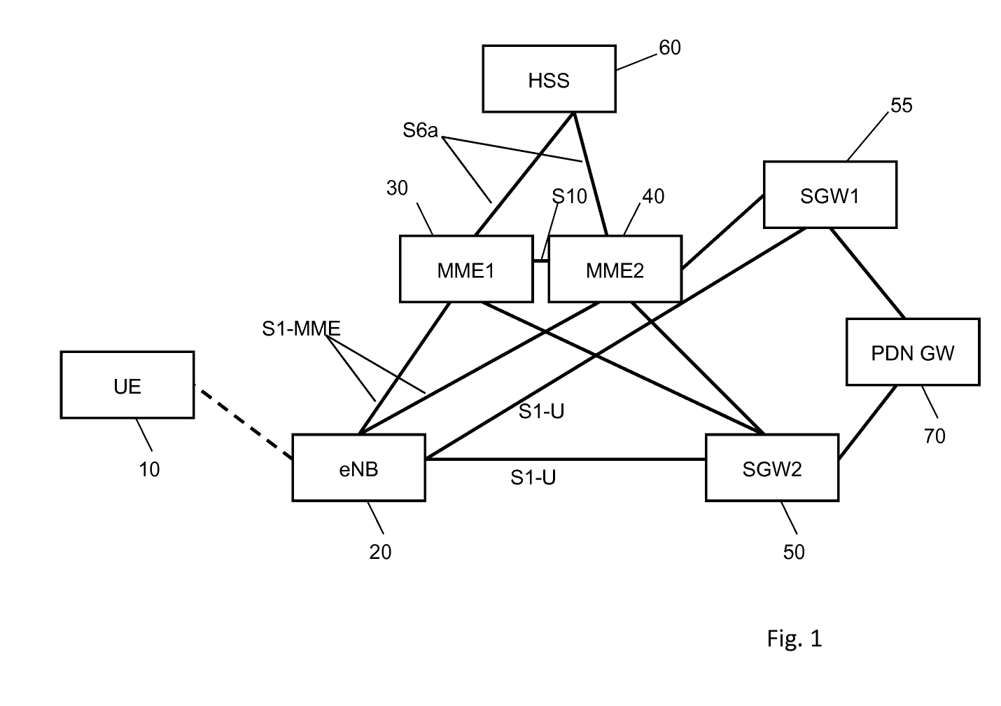

FIG. 1 shows a diagram illustrating a communication network configuration where some examples of embodiments of the invention are implemented. It is to be noted that the structure indicated in FIG. 1 shows only those devices, network elements and parts which are useful for understanding principles underlying some examples of embodiments of the invention. As also known by those skilled in the art there are several other network elements or devices involved in a communication between the communication element (UE) and the network which are omitted here for the sake of simplicity.

In FIG. 1, reference sign 10 denotes a communication element or terminal device such as a UE or the like which is capable of communicating with the communication network.

Reference sign 20 denotes a communication network control element such as a base station or eNB controlling a communication area or cell. The UE 10 communicates with the eNB 20 via one or more communication or data paths.

Reference signs 30 and 40 denote mobility management entities or MMEs, i.e. an MME1 and an MME2. In the structure shown in FIG. 1, it is assumed that the MMEs 30 and 40 belong to an MME pool wherein the eNB 20 is connected with both MME1 and MME2.

Reference sign 50 denotes a first gateway element such as an SGW which is connected to the MMEs 30 and 40 and to the eNB 20. The SGW 50 serves, for example, for packet routing and forwarding etc. Reference sign 55 denotes a second gateway element such as an SGW which is connected to MME 2 40 and the eNB 20.

Reference sign 60 denotes a home subscriber server element such as an HSS. The HSS 60 is a database that contains user-related and subscriber-related information and provides support functions in mobility management, call and session setup, user authentication and access authorization.

Reference sign 70 denotes a packet data network gateway (PDB GW), which is connected to SGW1 50 and SGW2 55. The PDN GW 70 is used, for example, for controlling tunnels to an SGW in case of mobility scenarios and for routing user plane packets.

The interfaces or reference points between the elements shown in FIG. 1 are commonly known to a person skilled in the art. For examples of embodiments of the invention, the following reference points or interfaces are to be considered: S1-MME, which is the reference point for the control plane protocol between the E-UTRAN (the eNB 20) and the MMEs (MME1, MME2); S1-U, which is the reference point between the E-UTRAN and the SGW1 50 or SGW2 55 for the per bearer user plane tunneling; S10, which is the reference point between MMEs (MME1 and MME2) for MME relocation and MME to MME information transfer; S6a, which is the reference point between an MME and the HSS for enabling a transfer of subscription and authentication data for authenticating/authorizing user access to the system.

As described above, in a conventional implementation example, when a load re-balancing procedure between MMEs is executed, the user experience is interrupted due to the movement of the UE 10 to a new (target) MME including a TAU procedure only, without making a handover prior to the TAU (user plane needs to be released and re-established).

In order to avoid this situation, according to some examples of embodiments of the invention, a handover of a connection of one or more subscribers from one mobility management entity, such as from MME1, to which the subscriber(s) is (are) currently attached, to another mobility management entity, such as from MME2, for load balancing purposes, which is triggered by the current mobility management entity, is conducted. In other words, in the system structure as shown in FIG. 1, a mechanism for an MME triggered S1 handover for load balancing purposes is provided.

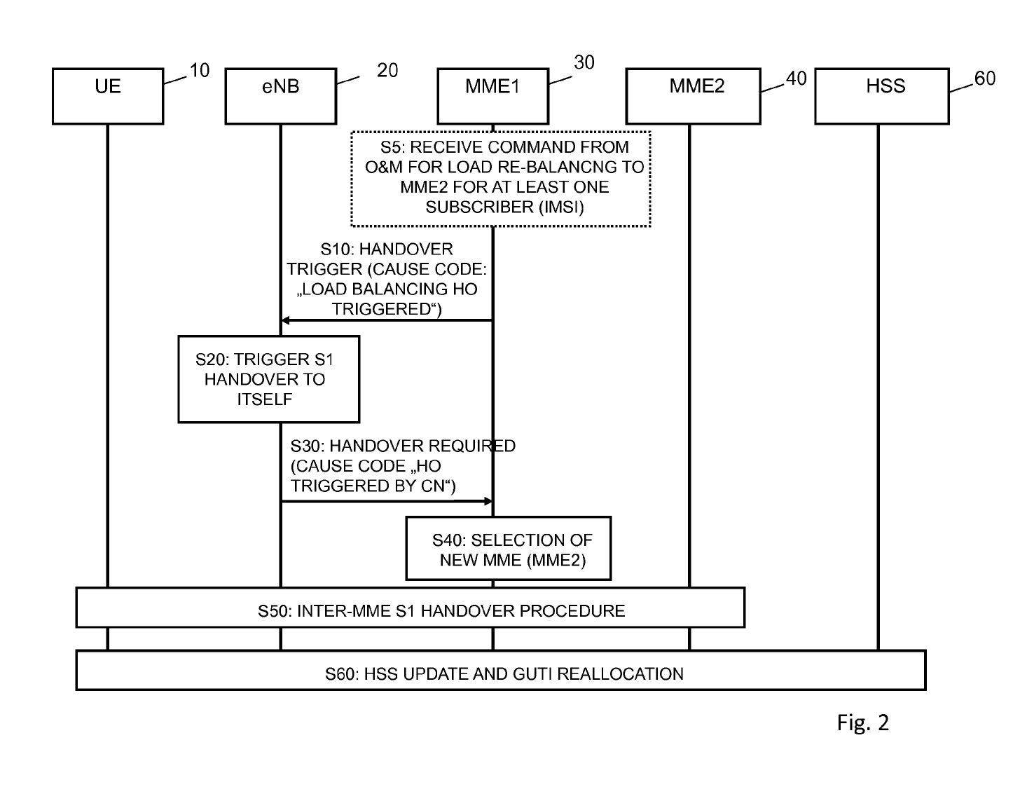

FIG. 2 shows a signaling diagram illustrating a general concept of such a mechanism for an MME triggered S1 handover procedure for load balancing purposes according to some examples of embodiments of the invention. It is to be noted that FIG. 2 shows a simplified network structure based on the configuration indicated in FIG. 1. In detail, some of the network elements which are not involved in steps described in connection with FIG. 2 for implementing the MME triggered S1 handover procedure, such as SGW1 50, SGW2 55, PDN GW 70, are omitted. Nevertheless, these elements may be involved in the execution of the handover procedure, as will be described later.

According to some examples of embodiments of the invention, the MME to which at least one subscriber (UE 10) is attached is enabled to trigger an inter-MME S1 handover for the UE 10 for load (re-)balancing purposes. That is, the current MME (MME1 30) is configured to cause a change for one or more UEs attached to it to another MME, for example to reduce the load of the current MME (for O&M purposes, for example). That is, an MME relocation is caused while maintaining the current cell and TA of the UE(s) in question.

According to some further examples of embodiments of the invention, the current MME is also able to select the target MME (i.e. the new MME to which the relocation procedure for the subscribers is to be done in the change process).

As indicated in FIG. 2 at step S10, for triggering the handover procedure, the MME1 30 as the current MME creates and sends a specific message via the S1-MME interface to the eNB 20 (e.g. as a new S1-AP message). The specific message is used by the MME1 30 to trigger a S1 based handover for a subscriber (or plural subscribers) into the existing cell (the identity of the subscriber in question is part of the handover trigger message, according to some examples of embodiments of the invention). In other words, even though an MME relocation is done and consequently the S1-MME connection is changed (i.e. a new MME is used), the UE 10 does not change the cell and TA, and the attachment or connection to the eNB 20 remains intact. That is, by means of the S1 based handover for load re-balancing, an MME change in the core network is triggered without changing the UE location (i.e. cell).

According to some examples of embodiments of the invention, the handover trigger message in step S10 comprises a specific cause code indicating that a load balancing handover is triggered.

It is to be noted that according to some examples of embodiments of the invention, an initial instruction or command for conducting a movement of one or more UEs from the current MME1 30 to another MME (and thus triggering the handover procedure) is given by e.g. a network operator or a further control element, such as an O&M element. This is indicated in FIG. 2 by step S5 being conducted before step S10. That is, in step S5, the current MME1 30 receives and processes a command from e.g. the network operator or an O&M element (not shown) which is an initial trigger to initiate the handover in the MME1 30. In this command, according to some examples of embodiments of the invention, also the subscriber to be changed is identified, e.g. by indicating a corresponding IMSI. It is to be noted that in case an indication for subscribers is not provided in the command, the MME1 30 is configured to determine the respective subscriber(s) by an own processing. According to some further examples of embodiments of the invention, the command initiator, i.e. the network operator or O&M element, specifies also a target MME for the load balancing handover (e.g. MME2 40). This information is then usable by the current MME1 30 in the further procedure (MME selection, to be described later).

When the eNB 20 receives the handover trigger message comprising e.g. the cause code “Load balancing handover triggered” from the MME1 30, the eNB 20 triggers or starts in step S20 a S1 handover to itself into the current cell. That is, according to some examples of embodiments of the invention, the eNB 20 is configured to start, in response to the handover trigger message with the specific cause code, an S1 based handover procedure in which the target for the handover of the UE 10 is set to the current cell (i.e. to the eNB 20), wherein also a target TA is set to the current TA, for example.

In step S30, the eNB 20 creates a handover required message and sends it to the MME1 30 (i.e. the current MME from which also the handover trigger message has been received) for indicating a specific type of handover is to be conducted (which results in that the MME for the specified subscribers (e.g. UE 10) is to be changed).

According to some examples of embodiments of the invention, the handover required message is sent as an S1-AP message and comprises a specific cause code indicating that the handover is triggered by a core network element (instruction).

For example, according to some examples of embodiments of the invention, the handover required message indicates, besides information related, for example, to context information of the UE 10, the current TA as a target TA, the current eNB identity of the eNB 20 as the target eNB identity, and the like. In other words, the handover required message indicates that the current cell and TA of the UE 10 is to be maintained. Furthermore, by means of a further indication, e.g. by means of the cause code, the MME1 30 determines that an MME relocation for the subscriber (UE 10) is possible to be executed according to MME1 30 decision (like in case of a “normal” handover, for example). That is, the current MME (MME1 30) is now able to utilize the handover initiated by the eNB 20 via this message in step S30 for the load re-balancing purposes and triggers e.g. a new MME selection for the at least one subscriber.

As indicated in step S40 of FIG. 2, according to some examples of embodiments of the invention, after the current MME1 30 has received the handover required message, a selection of the new MME (i.e. the MME to which UE 10 is to be moved) is executed. For example, according to some examples of embodiments of the invention, the selection of the new MME is based on an internal selection algorithm which is based for example on a conventional MME handover processing, for example an algorithm using a DNS query utilizing e.g. an indication of the new TA that the eNB 20 has indicated in the handover required message for the UE. In this case, as indicated above, the TA is the current TA of the UE 10, wherein the current MME (MME 30) recognizes that it serves this TA. However, since the current MME has initiated a load re-balancing procedure for the UE 10 (it has sent the handover trigger message in step S10), it knows that a new MME in this case is to be selected according to the original trigger to perform a load balancing handover, i.e. the target MME may be selected according to e.g. the network operator or O&M trigger. According to some examples of embodiments of the invention, the selection algorithm is configured such that a change of e.g. a SGW due to the MME change is avoided, i.e. that the new MME is connected also to the same SGW as the current MME (otherwise, user plane endpoints have to be modified causing user experience delay by packet forwarding). Furthermore, according to some examples of embodiments of the invention, an indication given by an initiator or another control element, such as the network operator or O&M element initially instructing the handover procedure, is considered in the selection of the new MME.

In step S50, the inter-MME S1 handover procedure is conducted or continued at least between the network elements involved therein, i.e. the UE 10, the eNB 20, the MME1 30 and the MME2 40. It is to be noted that according to some examples of embodiments of the invention, the target MME (here MME2 40) is configured to support a handover cause value which is used by the eNB 20 initially requiring the handover (step S30). In the processing according to step S50, several steps for conducting and continuing the inter MME handover are executed. For example, according to some examples of embodiments of the invention, corresponding steps comprises following parts. A relocation related message is sent, such as a Forward relocation request from the current MME1 30 to the new MME2 40 (which comprises e.g. information derived from the handover required message, such as a target eNB identification, the selected TA etc.). The Forward Relocation Request causes the new MME2 40 to further trigger a handover resource allocation procedure and to send a handover request to the eNB 20, establishing a new S1-AP logical signaling connection (the eNB20 is both the “old” and the “new” eNB in a handover point of view). As a response to the handover request, the eNB 20 sends back to the MME2 40 an acknowledge message to the handover request. The acknowledgement message triggers a sending-back of a Forward Relocation Response from the new MME2 40 to the current (or old) MME1 30. Then the old MME1 30 sends a handover command message to the eNB 20.

It is to be noted that, according to different examples of embodiments of the invention, the above listed steps can be reduced or added by some steps, or other steps having a similar meaning can be employed. For example, steps described in corresponding specifications and being related to an inter MME handover procedure can be added to the above listed steps, as far as they are suitable. Otherwise, in case a corresponding system where examples of embodiments of the invention are applied does not require certain ones of the above steps, they can be omitted then. The processing described above in connection with step S50 is intended for giving a general overview how an inter MME handover can be executed, and a result of step S50 in a procedure according to examples of embodiments of the invention is to continue the inter MME handover procedure being initiated by the preceding steps S10 to S40.

With regard to the UE 10 connection to the eNB 20, according to some examples of embodiments of the invention, the handover procedure is transparent to the UE 10 and a connection mapping is done in the eNB 20, so that the UE 10 is not aware of the MME change thereof. Alternatively, according to some examples of embodiments of the invention, a “virtual” handover procedure for the UE 10 is executed where the eNB 20 acts as both the old and the new eNB. Consequently, the handover procedure according to some examples of embodiments of the invention provides a seamless mobility.

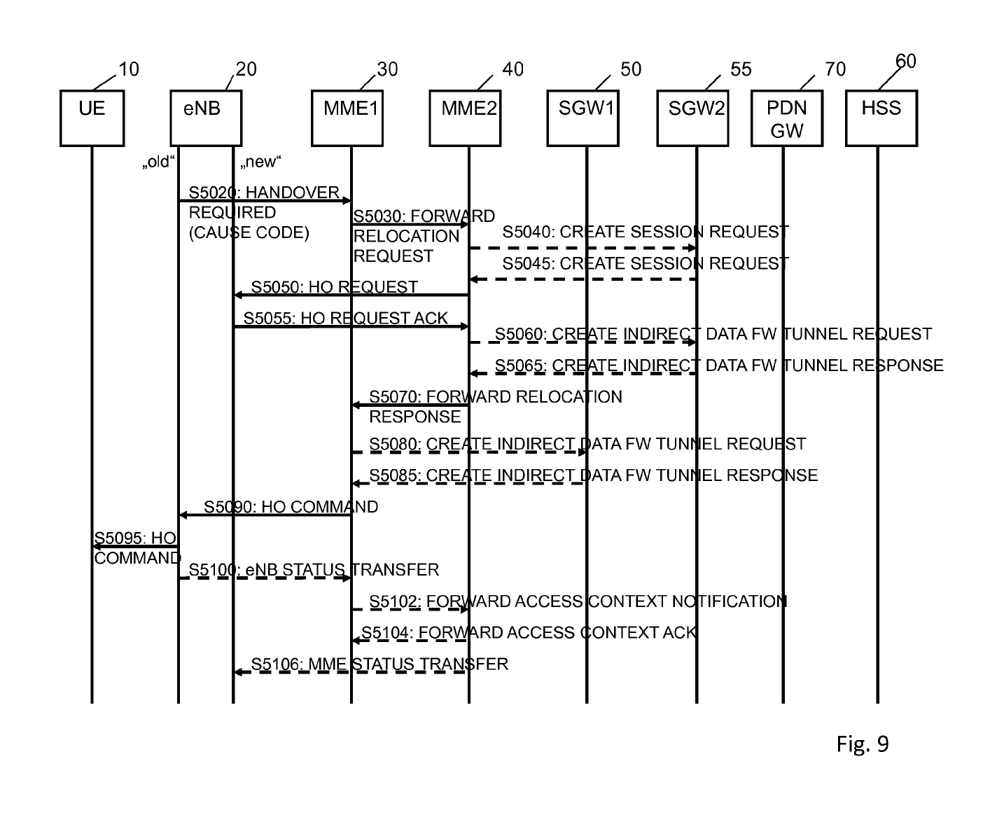

In the following, with regard to S50 where the inter MME S1 handover procedure is indicated to be conducted, further examples of embodiments will be described regarding alternative aspects for the execution or continuation of the handover procedure. Specifically, reference is made to an inter MME S1 handover procedure as illustrated in FIGS. 9 to 11.

As discussed above, according to examples of embodiments being based on a processing as described in connection with steps S10 to S40, an MME has triggered a handover for load balancing purpose wherein also a target MME for the UE may be selected.

According to the now described examples of embodiments, the handover used for load rebalancing is optimized by modifying a configuration of the handover procedure e.g. in comparison to a configuration of a default handover procedure (e.g. an inter MME S1 based handover procedure not being triggered by the MME but by the eNB). In detail, according to some examples of embodiments, at least parts of the handover related signaling is modified or even skipped.

For example, signaling related to data forwarding, PDCP status related signaling, UE related radio interface signaling is a target for the modification. Furthermore, measurement related signalling, status transfer signaling, SGW relocation signaling and handover notification signalling is a target.

According to examples of embodiments of the invention, the eNB 20 and the MMEs (i.e. MME1 30 and MME2 40) are aware of the special type of handover procedure initiated by means of the processing related to steps S10 to S40. This is achieved, for example, by means of the indications comprised in the related signalling, such as the special cause code values in the handover trigger message (S10) or the handover required message (S30), which indicate an offloading purpose handover. Thus, in order to optimize the handover procedure with regard to a signalling or processing load, the configuration of a default handover procedure may be modified or adjusted in such a manner that the special conditions regarding this special handover type (e.g. same TA, same cell or eNB) are considered.

Specifically, according to some examples of embodiments, the eNB 20 and the MME1 30 as well as the MME2 40 may adapt the configuration of the handover procedure to be conducted in this case in such a manner that they act differently. For example, content of signals or whole signalling sequences are modified or skipped on the sending side, wherein the receiving side accepts this modification or skipping and continues the handover processing e.g. on the basis of internally stored data.

It is to be noted that according to some examples of embodiments the examples of modifications described in the following are optional for a load balancing handover procedure. Unless explicitly stated otherwise, all optimizations indicated in the following may be implemented separately and independently from each other. Basically, a load balancing handover procedure can also be performed without such modifications, i.e. in accordance with a default handover procedure.

Referring to FIG. 9 to FIG. 11, a signaling diagram illustrating a handover procedure according to some examples of embodiments of the invention is shown. The diagrams of FIGS. 9 to 11 are to be understood as one connected diagram in the order of the figures. Basically, the signaling diagram according to FIGS. 9 to 11 illustrates basically all steps executed in a default inter MME S1 based handover procedure wherein optionally also a case is illustrated where in addition to an MME handover a SGW handover is performed. Therefore, in addition to the elements indicated in connection with FIG. 2, SGW1 50, SGW2 55, and PDN GW 70 are indicated as being involved.

Furthermore, with regard to eNB 20, as discussed above, since the cell (and due to that, also not the eNB) is not to be changed in the handover procedure, the eNB 20 represents both a source eNB and a target eNB in the handover procedure. For indicating this double role, two lines indicated by “old” (for the source eNB role) and “new” (for the target eNB role) are provided.

It is assumed that a load rebalancing handover procedure as described e.g. in connection with steps S10 to S40 of FIG. 2 is initiated in the network. Hence, the network elements eNB 20, MME1 30 and (later) MME2 40 can determine that a type of a handover procedure to be executed is not a default handover procedure but a special handover procedure in which a change from a current MME to a new MME is to be executed while a current cell (eNB 20) and TA of UE 10 is kept unchanged. Thus, a configuration of the handover procedure to be executed can be modified from the default setting to a modified setting being different to the default setting.

For example, according to some examples of embodiments, since the handover to be executed for load rebalancing purposes is made as a handover to the eNB 20 itself and thus the handover target cell is identical to the handover source cell, it is not necessary that the eNB requests any measurements from the UE 10 or that measurement reports received from the UE 10 are to be evaluated in connection with the handover procedure. This represents a first example of options for modifying a default handover procedure, for example.

Referring now to FIG. 9, in S5020, a handover required is sent from the eNB 20 to the MME1 30. The handover required message in S5020 corresponds to S30 in FIG. 2, for example. According to the default handover procedure, the handover required comprises several information, such as a direct forwarding path availability, a source to target transparent container, target eNB ID, etc. Furthermore, the source eNB indicates which bearers are subject to data forwarding. Direct forwarding path availability indicates whether direct forwarding is available from the source eNB to the target eNB. According to some examples of embodiments, the complexity of the handover required message in case of a handover procedure as initiated by the procedure according to FIG. 2, for example, can be reduced. For example, an indication of a target eNB ID is not necessary since it is the same as that of the source eNB. Moreover, it is not necessary to provide transparent containers via external interfaces which, in the default handover configuration, would be forwarded from the source eNB via the MME to the target eNB. Also “direct forwarding path availability” may not be indicated as data forwarding may be completely skipped. This represents a second example of options for modifying a default handover procedure, for example.

In S5030, based on the selection made e.g. in step S40, the source MME MME1 30 sends a forward relocation request message to the target MME (MME 2 40). The forward relocation request message comprises e.g. information related to MME UE context, Source to Target transparent container (which may be omitted, see also step S5020), target eNB ID, closed subscriber group related information, target TAI, UE time zone, direct forwarding flag, etc. The target TAI is sent to the target MME to help it to determine whether SGW relocation is needed (and, if needed, aid SGW selection). The MME UE context may include information related to IMSI, UE security context, UE network capability, (current) SGW address and TEID for control signaling, and EPS Bearer context(s) (comprising e.g. PDN GW related information like addresses and TEIDs for uplink traffic, SGW addresses and TEIDs for uplink traffic, etc.). Furthermore, the forward relocation request may include an indication related to the type of the handover (e.g. a cause code or the like) indicating the specific type of handover.

The target MME (MME2 40) may be set as the instance regarding a decision of keeping or changing the SGW (i.e. change from SGW1 50 to e.g. SGW2 55. For example, as the UE has not moved, the SGW may be kept. Nevertheless, according to some examples of embodiments, the final decision regarding conducting or not an additional further relocation of the SGW (i.e. to keep the SGW or to enable SGW relocation) may reside in the target MME. For example, this decision is based on further configuration settings, such as a coupling of the target MME with a specific SGW, or more generally a certain TA coupling with a certain SGW. As the TA is not changed in this special type of handover, the validation whether to change SGW may also be skipped. That is, based on the information received in S5030, the target MME MME2 40 verifies whether the current source SGW (SGW1 50) can continue to serve the UE 10. If not, MME2 40 selects a new SGW, e.g. SGW2 55. This may be based e.g. on a SGW selection function, a pre-set coupling to a specific SGW defined in DNS configuration. This represents a third example of options for modifying a default handover procedure, for example.

In case a new SGW (i.e. SGW2 55) is determined or selected, the target MME MME2 40 sends in S5040 a create session request message to the SGW2 55 which includes information about bearer context(s) with PDN GW addresses and TEIDs for uplink traffic, UE time zone etc. per PDN connection. The target SGW SGW2 55 allocates the SGW addresses and TEIDs for the uplink traffic on S1_U reference point (one TEID per bearer). The target SGW (SGW2 55) sends a create session response in S5045 back to the target MME (MM2 40) which includes e.g. information about SGW addresses and uplink TEID(s) for user plane. Of course, in case the SGW does not change, messages according to S5040 and S5045 are not sent.

According to a default handover procedure, the target MME (MME2 40) sends in S5050 a handover request message to the target eNB. The handover request comprises in the default handover procedure, for example, information related to EPS bearers to setup, Source to Target transparent container, handover restriction list, etc., for creating the UE context in the target eNB, including information about the bearers, and the security context. However, since according to some examples of embodiments, in the special handover procedure, the source or “old” eNB is identical to the target or new eNB (i.e. eNB 20), the “target eNB” is already aware about the UE context. Therefore, the complexity of the Handover Request message can be reduced by referencing e.g. to the available UE context, instead of providing a full new configuration of the related UE. In other words, the amount of information provided with the handover request message can be reduced. This represents a fourth example of options for modifying a default handover procedure, for example.

In S5055, the target eNB (eNB 20) sends a handover request acknowledge message to the target MME (MME2 40) including information related to EPS bearers (e.g. a list of addresses and TEIDs allocated at the eNB for downlink traffic on S1-U reference point (one TEID per bearer) and addresses and TEIDs for receiving forwarded data if necessary). According to some examples of embodiments, in the special handover procedure, S5055 may be modified further by using it as a trigger for e.g. starting a modify bearer request procedure (described later) between the target MME (MME2 40) and a new SGW (SGW2 55) in case of an SGW change. Furthermore, S5055 may be used also as a trigger for conducting a GUTI reallocation and HSS update procedure (to be described later in connection with S60 of FIG. 2) to be performed after completion of the handover procedure for rebalancing reasons). This represents a fifth example of options for modifying a default handover procedure, for example.

In a default handover procedure, S5060 and S5065 may be executed which are related to indirect forwarding in case of SGW relocation, and which concern a create indirect data forwarding tunnel request and response. However, according to some examples of embodiments, the target MME and the eNB can skip indirect data forwarding in the special handover procedure for load rebalancing. As the target eNB is the same as source eNB, data forwarding can be handled completely eNB internally so that external transport resources are saved and a delay is reduced. Consequently, processing and signalling according to S5060 and S5065 can be omitted. This represents a sixth example of options for modifying a default handover procedure, for example.

In S5070, the target MME (MME2 40) sends to the source MME (MME1 30) a forward relocation response message including information related to a cause, a SGW change indication (if any), EPS bearer setup list, addresses and TEIDs.

In a default handover procedure, S5080 and S5085 may be executed which are related, similar to S5060 and S5065, to indirect forwarding. That is, in case indirect forwarding applies, the source MME sends a create indirect data forwarding tunnel request to the (source) SGW (in case of SGW relocation, also tunnel identifier to the target SGW is included). The SGW responds with a create indirect data forwarding tunnel response to the source MME. However, according to some examples of embodiments, as indicated above, the target MME and the eNB can skip indirect data forwarding in the special handover procedure for load rebalancing. As the target eNB is the same as source eNB, data forwarding can be handled completely eNB internally so that external transport resources are saved and a delay is reduced. Consequently, processing and signalling according to S5080 and S5085 can be omitted. This represents an eighth example of options for modifying a default handover procedure, for example.

In the default handover procedure, in S5090, the source MME sends a handover command message to the source eNB, wherein the handover command may include information related to a target to source transparent container, bearers subject to forwarding, and bearers to be released. In the target eNB, a handover command for the UE is constructed and sent in S5095 to the UE. However, according to some examples of embodiments, in the special handover procedure for load rebalancing, the UE 10 remains in the same cell and there is consequently no need to force the UE 10 to perform an access procedure to a new cell (e.g. a RACH access procedure to the eNB). Hence, the eNB 20 may skip the UE related signalling during the handover procedure. This saves resources and makes also the whole special handover procedure transparent to the UE 10. In other words, the UE 10 can be kept not aware of the offloading triggered handover. Making handover transparent to the UE 10, as an advantage of the special handover procedure, results in that the UE 10 does not suffer from the a user plane interruption time during handover (which may be caused in case of the default handover procedure where typically a service impact by e.g. increased delay, reduced data rate or even data loss is the result). Consequently, processing and signalling according to S5095 can be omitted, and that according to S5090 can be modified. This represents a ninth example of options for modifying a default handover procedure, for example.

In S5100, S5102, S5104 and S5106, according to a default handover procedure, the source eNB sends an eNB status transfer message to the target eNB via the MME(s) to convey information such as PDCP and HFN status. The source MME sends this information to the target MME via forward access context notification message (S5102) which the target MME acknowledges (S5104). The target MME, sends the information to the target eNB via MME status transfer message (S5106). However, according to some examples of embodiments, in the special handover procedure for load rebalancing, as the source eNB is the same as target eNB, the eNB 20 and the MMEs are able to skip a PDCP sequence number delivery and thus the eNB/MME status transfer procedure of S5100 to S5106. A PDCP status may be exchanged internally in the eNB 20, or it is not needed at all if handover is performed transparently to UE 10. Consequently, processing and signalling according to S5100 to S5106 can be omitted or at least modified. This represents a tenth example of options for modifying a default handover procedure, for example.

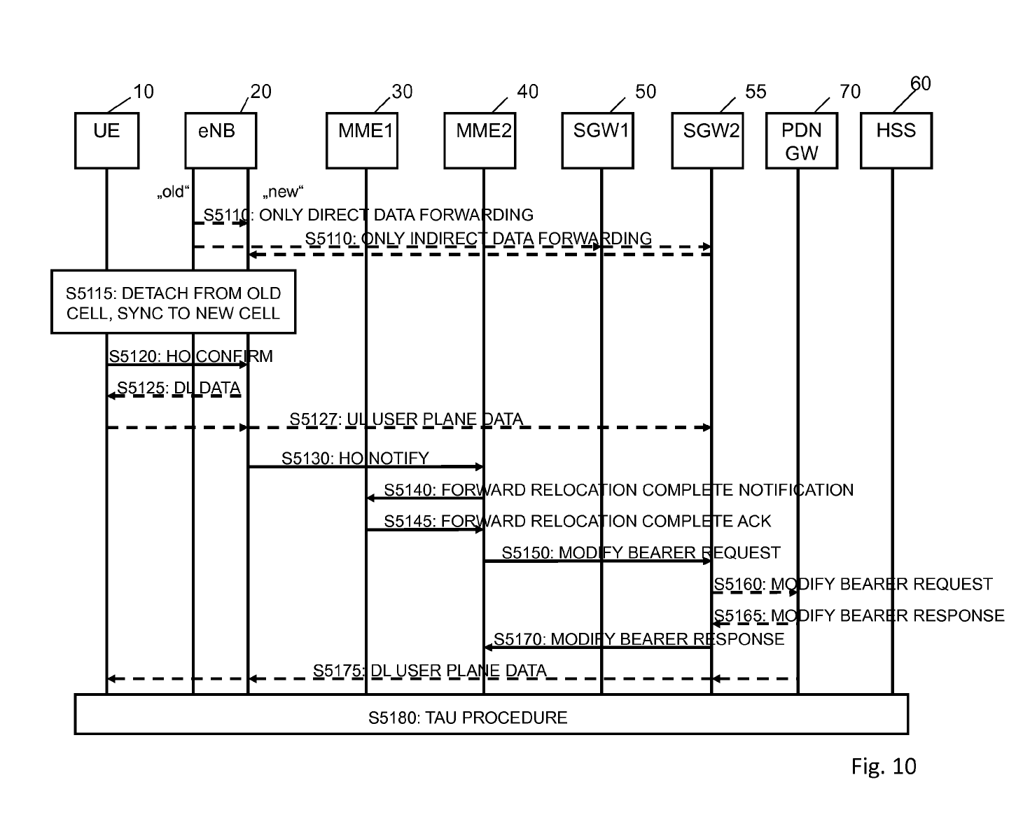

Referring to FIG. 10, which shows processing and steps directly following the processing and steps indicated in FIG. 9, in the default handover procedure, in S5110, the source eNB may start forwarding of downlink data from the source eNB towards the target eNB for bearers subject to data forwarding either by direct or indirect forwarding. As indicated above, according to some examples of embodiments, the eNB can skip direct or indirect data forwarding in the special handover procedure for load rebalancing. As the target eNB is the same as source eNB, data forwarding can be handled completely eNB internally so that external transport resources are saved and a delay is reduced. Consequently, processing and signalling according to S5110 can be modified into internal signalling. This represents an eleventh example of options for modifying a default handover procedure, for example.

In the default handover procedure, in S5115, the UE detaches from the old cell and synchronizes to the new target cell. After the UE has successfully synchronized to the target cell, it sends in S5120 a handover confirm message to the target eNB. Then, in S5125, DL packets forwarded from the source eNB can be sent to the UE. Also, UL packets can be sent from the UE (see S5127), which are forwarded to the (target) SGW and on to the PDN GW. However, according to some examples of embodiments, as also discussed in connection with S5095, in the special handover procedure for load rebalancing, the UE 10 remains in the same cell and there is consequently no need to force the UE 10 to perform an access procedure to a new cell (e.g. a RACH access procedure to the eNB). Thus, the eNB-UE related signalling during the handover procedure may be skipped, and the whole special handover procedure is transparent to the UE 10. The UE 10 does not suffer from a user plane interruption time during handover. Consequently, processing and signalling according to S5115 to S5127 can be omitted or modified. This represents a twelfth example of options for modifying a default handover procedure, for example.

In the default handover procedure, in S5130, the target eNB sends a handover notify message to the target MME. It is to be noted that in case the handover is performed transparently to the UE, according to some examples of embodiments, a separate handover notify message can be skipped, since the MME can assume that a handover has been completed immediately when sending e.g. the handover command (according to S5090). Consequently, processing and signalling according to S5130 can be omitted. This represents a thirteenth example of options for modifying a default handover procedure, for example.

Furthermore, it is to be noted that a negotiation between the eNB 20 and the target MME2 40 may be executed according to some examples of embodiments where it is negotiated whether the handover notify message can be cancelled. This negotiation may be executed, for example, by using any of the messages regarding handover required (S5020), handover request (S5050), handover request acknowledge (S5055) or handover command (S5090). Consequently, the contents of these messages may be modified. This represents a fourteenth example of options for modifying a default handover procedure, for example.

In the default handover procedure, in S5140, the target MME sends a forward relocation complete notification message to the source MME. The source MME sends in S5145 a forward relocation complete acknowledge message to the target MME. However, according to some examples of embodiments, as the UE is not really detected in a new cell and handover notify may be skipped, the processing and signaling in S5140 and S5145 may be not required and can be skipped. This represents a fifteenth example of options for modifying a default handover procedure, for example.

In the default handover procedure, in S5150, the new MME sends a modify bearer request message to the target SGW for each PDN connection including the PDN connections that need to be released. The modify bearer request message may comprise information related to an eNB address and TEID allocated at the target eNB for DL traffic. As indicated above, according to some examples of embodiments, S5140 and S5145 may be omitted. In this case, the trigger for sending send a modify bearer request, i.e. to start a bearer modification at the SGW, may be provided by the signaling in S5055. This represents a sixteenth example of options for modifying a default handover procedure, for example.

In case the SGW is relocated, according to the default handover procedure, the target SGW assigns addresses and TEIDs (one per bearer) for DL traffic from the PDN GW. In S5160, a modify bearer request message per PDN connection is sent to the PDN GW 70. The PDN GW 70 updates its context field and returns a modify bearer response in S5165 to the target SGW.

In S5170, according to the default handover procedure, the SGW returns a modify bearer response message to the MME as a response to a modify bearer request message. In S5175, DL packets can be sent to the UE 10.

In the default handover procedure, in S5180, the UE initiates a TAU procedure based on certain conditions. Also the target MME performs a TAU procedure. However, according to some examples of embodiments, in the special handover procedure, a TAU procedure is not performed by the UE 10 as the TA in which the UE 10 camps on is not to be changed. Consequently, processing and signalling according to S5180 can be omitted. This represents a seventeenth example of options for modifying a default handover procedure, for example.

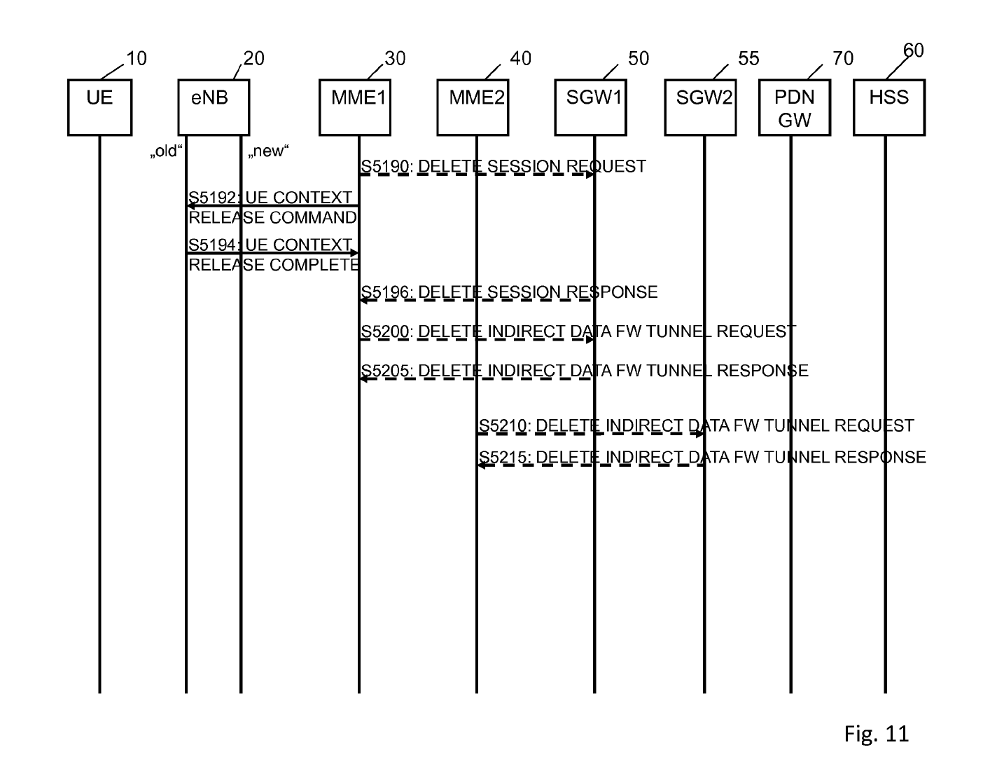

Referring to FIG. 11, which shows processing and steps directly following the processing and steps indicated in FIG. 10, in the default handover procedure, in S5192, the source MME sends a UE context release command message to the source eNB. The source eNB releases its resources related to the UE and responds in S5194 with a UE context release complete message. Furthermore, in case also the SGW has changed from a source SGW to a target SGW (indicated in S5070, for example), the source MME deletes the EPS bearer resources by sending in S5190 a delete session request message to the source SG, wherein a delete procedure towards the PDN GW is inhibited. The source SGW acknowledges with a delete session response messages in S5196. However, as indicated above, according to some examples of embodiments, the target MME (MME2 40) may be set as the instance regarding a decision of keeping or changing the SGW (i.e. change from SGW1 50 to e.g. SGW2 55). For example, as the UE has not moved, the SGW may be kept. Nevertheless, according to some examples of embodiments, the final decision regarding a relocation of the SGW (i.e. to keep the SGW or to enable SGW relocation) may reside in the target MME. Consequently, the processing and signalling according to S5190 and S5196 may be omitted. This represents a eighteenth example of options for modifying a default handover procedure, for example. Moreover, as the eNB has not changed, the UE context release procedure in S5192 and S5194 is not required. Consequently, the processing and signalling according to S5192 and S5194 may be omitted. This represents a nineteenth example of options for modifying a default handover procedure, for example.

In the default handover procedure, in case an indirect forwarding was used, the source MME is triggered in S5200 to send a delete indirect data forwarding tunnel request message to the SGW to release the temporary resources used for indirect forwarding that were allocated at S5080 and S5085. This is responded in S5205 by the target SGW by a delete indirect data forwarding tunnel response message. Similarly, in S5210 and S5215, in case indirect forwarding was used and the SGW is relocated, then the target MME is triggered to send a delete indirect data forwarding tunnel request message to the target SGW to release temporary resources used for indirect forwarding that were allocated at S5060. This is responded by the target SGW by a delete indirect data forwarding tunnel response message. However, according to some examples of embodiments, in the special handover procedure, the MME and the eNB may skip any direct or indirect data forwarding in the load balancing handover procedure (target eNB is the same as source eNB, so that data forwarding can be handled internally in the eNB). Consequently, processing and signalling according to S5200, S50205, S5210, and S5215, respectively can be omitted. This represents a twentieth example of options for modifying a default handover procedure, for example.

As illustrated in connection with FIGS. 9 to 11, compared to a default handover procedure, it is possible, by implementing one or more of the described options for modifying the default handover procedure in connection with the special handover procedure for load rebalancing purposes based e.g. on a processing as indicated in FIG. 2, to reduce a signalling load on the network to a minimum, wherein for example measurement related signalling, UE related signalling, data forwarding, status transfers, SGW relocation and handover notification signalling may is not performed during the handover.

Back to FIG. 2, assuming that the handover of the MME (MME relocation) from old MME1 30 to new MME2 40 is completed in step S50, step S60 is conducted.

In view of the fact that the UE 10 is not aware of the MME change or is at least not subjected to a TA change, bearer change or the like (it is still connected to the same cell), there is no reason for it to conduct a TAU (which would be the case when a handover with cell change is conducted in a conventional processing). Nevertheless, when executing the handover procedure for changing the MME as described above, it is necessary to update for example the control point of the bearer (MME) as well as a HSS registration for the subscriber (UE 10) moved to the new MME2 40.

Therefore, according to some examples of embodiments of the invention, in step S60, immediately after the inter MME handover is completed in step S50, the new MME2 40 further updates the HSS 60 by informing about the change of the MME, for example by sending an update location request message via the S6a interface to update the HSS registration. In response, the HSS 60 answers to the MME2 40 with an update location answer (comprising e.g. the IMSI of the UE 10 and subscription date) in case the registration update to new MME (MME2 40) is successful.

According to some examples of embodiments of the invention, in connection with the update location request/answer exchange with the new MME2 40, the HSS 60 conducts also a cancel location processing with the old MME1 30, which comprises for example to send from the HSS 60 to the old MME1 30 a cancel location message including a cancellation type indication and the IMSI of the UE 10. The MME1 30 removes then the mobility management and the bearer contexts of the UE 10 and acknowledges this by sending from the old MME1 30 to the HSS 60 a cancellation location acknowledgement, for example.

Furthermore, in step S60, after receiving the update location answer from the HSS 60, i.e. when the HSS update procedure is completed, the new MME2 40 conducts a, identity reallocation procedure, such as a GUTI reallocation procedure, with the UE 10. GUTI reallocation is usable for allocating a (new) GUTI and/or a (new) TA list to the UE. For this purpose, the new MME2 40, sends a reallocation command message, such as a NAS GUTI reallocation command to the UE 10, to allocate a new GUTI with the new TA list from new MME2 40. The UE responds with a corresponding answer message, such as a GUTI reallocation complete message. Consequently, the UE 10 can be triggered to conduct a TAU procedure, but since the UE location does not change, the required parts of the TAU procedure are executable from MME point of view in a manner that UE gets a new temporary identity and TA list allocated.

It is to be noted that in the handover procedure of step S50 or in the HSS update procedure also a rejection is a possible result for some reasons. In this case, the change of the MME from MME1 30 to MME2 40 is stopped or cancelled.

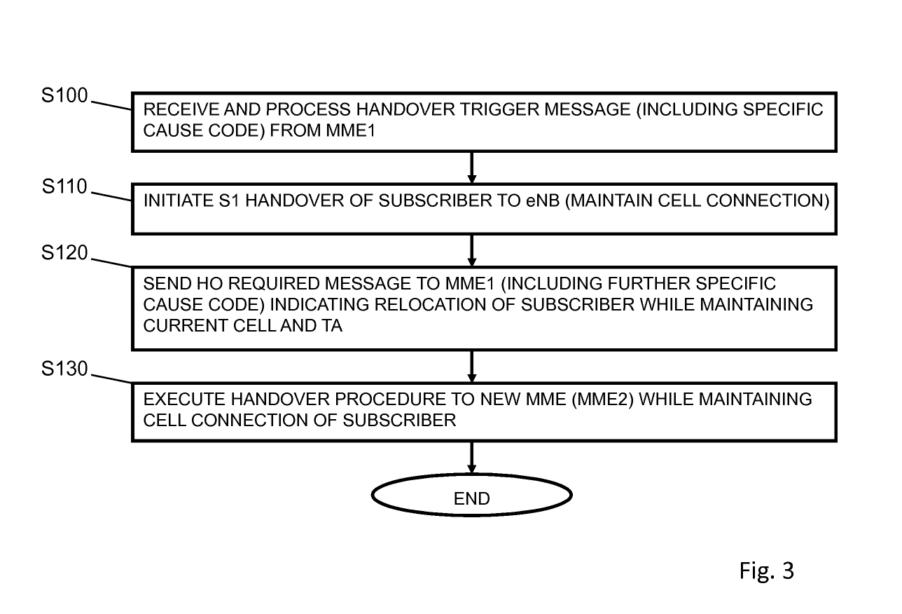

FIG. 3 shows a flowchart illustrating a processing executed in a communication network control element like the eNB 20 of FIG. 1 according to some examples of embodiments of the invention.

In step S100, a handover trigger message is received and processed which indicates that a change of at least one subscriber attachment from a current mobility management entity to a new mobility management entity (i.e. an MME relocation) is to be executed while a current cell and tracking area of the at least one subscriber is kept unchanged (in other words, a handover with MME relocation but to the same eNB). The handover trigger message is received from the current mobility management entity. According to some examples of embodiments of the invention, the handover trigger message comprises a first specific cause code indicating that the change of the at least one subscriber attachment from the current mobility management entity is due to a load balancing process.

In step S110, a handover of a S1 connection for the at least one subscriber from the current mobility management entity to a new mobility management entity is initiated (while maintaining the current cell and tracking area of the at least one subscriber). According to some examples of embodiments of the invention, for maintaining the current cell and tracking area of the at least one subscriber, a handover procedure for the at least one subscriber is started to the same cell (i.e. the same eNB 20) to which the subscriber is currently attached (e.g. by setting the current cell (eNB 20) and the current TA as the target cell and TA).

In step S120, a handover required message for indicating the requirement of a relocation of the at least one subscriber attachment to the current (same) cell and tracking area (i.e. the cell and TA are maintained even though a relocation is to be done) is created and send to the current mobility management entity (MME1 30). According to some examples of embodiments of the invention, the handover required message comprises a second specific cause code indicating that the requirement of the relocation of the at least one subscriber attachment to the current cell and TA is due to a command from a core network element.

In step S130, a handover procedure is executed. That is, communication with the current mobility management entity and a new mobility management entity is conducted for completing (or terminating) the handover of the S1 connection for the at least one subscriber from the current mobility management entity to the new mobility management entity while maintaining the current cell and tracking area (i.e. at eNB 20) of the at least one subscriber. For example, the current cell identity and TA indication are used as target values for the handover procedure.

According to some examples, a type of a handover procedure to be executed is determined as being either a default handover procedure or a special handover procedure in which a change from a current mobility management entity to a new mobility management entity is to be executed while a current cell and tracking area of the at least one subscriber is kept unchanged. In case the special handover procedure is determined, a configuration of the handover procedure to be executed can modified from a default setting to a modified setting being different to the default setting. According to some examples, the determination of the type of the handover procedure to be conducted is based on an indication received in the handover trigger message (such as the specific cause code indicated above). Furthermore, the modified setting may comprises at least one of: at the sender side (i.e. messages sent from the eNB 20), a modification of a content of at least one signaling sent in the handover procedure by at least one of adding, amending and omitting of at least one parameter or at least one value comprised in a corresponding signaling sent in the default handover procedure, at the receiver side (i.e. messages received and processed at the eNB 20), the acceptance and processing of a modified content in at least one signaling received in the handover procedure, the modified content being changed in comparison to a content received in the default handover procedure by at least one of adding, amending and omitting of at least one parameter or at least one value comprised therein, at the sender side (i.e. messages sent from the eNB 20), skipping of at least one signaling being sent in the default handover procedure, and, at the receiver side (i.e. messages received and processed at the eNB 20), the acceptance of a skipping of at least one signaling being received in the default handover procedure, and using data being internally stored instead of the at least one skipped signaling.

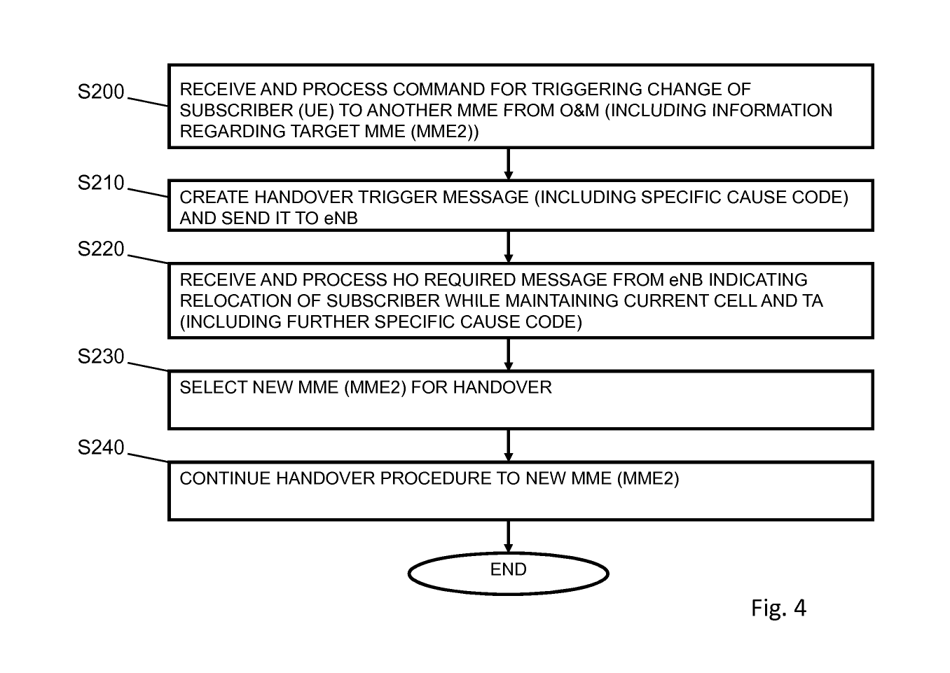

FIG. 4 shows a flowchart illustrating a processing executed in a mobility management entity being a source or old (current) mobility management entity, like the MME1 30 of FIG. 1 according to some examples of embodiments of the invention.

In step S200 (which is optional according to some examples of embodiments of the invention), the current MME receives and processes a command for initiating a change of at least one subscriber attachment from a current mobility management entity to a new mobility management entity due to load re-balancing reasons. The command is received e.g. from a network operator or an operation and maintenance element. Furthermore, according to some examples of embodiments of the invention, the command further comprises an indication of an identity of a target mobility management entity to be used as a new mobility management entity in the handover procedure.

In step S210 (e.g. in reaction to the command in step S200, or by a decision made in the current MME1 30 itself), a handover trigger message is created and sent to a cell (eNB 20) where a subscriber (UE 10) to be moved to a new MME is located. The handover trigger message indicates that a change of at least one subscriber attachment from a current mobility management entity to a new mobility management entity is to be executed while a cell and tracking area of the at least one subscriber is kept unchanged.

According to some examples of embodiments of the invention, the handover trigger message comprises a first specific cause code indicating that the change of the at least one subscriber attachment from the current mobility management entity is due to a load balancing process.

In step S220, a handover required message is received and processed. The handover required message is received from the eNB 20 to which the subscriber in question is attached, and concerns an indication of a requirement of a relocation to the current cell and tracking area (i.e. an MME relocation while the current cell and TA are maintained). The current MME now may utilize this handover initiated by the eNB for the load re-balancing purposes and trigger new MME selection for the at least one subscriber. According to some examples of embodiments of the invention, the handover required message comprises a second specific cause code indicating that requirement of the relocation of the at least one subscriber attachment to the current cell and tracking area is due to a command from a core network element.

In step S230 (which is also optional according to some examples of embodiments of the invention), the current MME (e.g. MME1 30) selects the new mobility management entity to which the handover of the S1 connection for the at least one subscriber from the current mobility management entity is to be continued. According to some examples of embodiments of the invention, the selection of the new mobility management entity is based on an internal selection algorithm (e.g. related to a result that an SGW does not need to be switched due to the MME handover), or an indication of an identity of a target mobility management entity to be used as the new mobility management entity received from an operation and maintenance element (e.g. in step S200).

In step S240, the handover procedure of the S1 connection for the at least one subscriber from the current mobility management entity to the new mobility management entity is continued. For example, according to some examples of embodiments of the invention, when step S230 is implemented, the handover procedure of the connection is continued to the selected mobility management entity. According to some examples of embodiments of the invention, for continuing the handover procedure, a communication with the communication network control element (eNB 20) to which the at least one subscriber is attached and the new mobility management entity (MME2 40) is conducted for continuing the handover procedure for the connection for the at least one subscriber from the current mobility management entity to the new mobility management entity while maintaining the current cell and tracking area of the at least one subscriber.

According to some examples of embodiments, the handover procedure continued in S240 may comprise a determination of a type of a handover procedure to be continued as being a default handover procedure or a special handover procedure in which a change from a current mobility management entity to a new mobility management entity is to be executed while a current cell and tracking area of the at least one subscriber is kept unchanged. In case it is the special handover procedure, a configuration of the handover procedure to be continued may be modified from a default setting to a modified setting being different to the default setting. For example, the determination of the type of the handover procedure to be continued is based on an indication received in the handover required message, for example by means of the specific cause code. Furthermore, the modified setting may comprises at least one of: at the sender side (i.e. messages sent from the MME1 30), a modification of a content of at least one signaling sent in the handover procedure by at least one of adding, amending and omitting of at least one parameter or at least one value comprised in a corresponding signaling sent in the default handover procedure, at the receiver side (i.e. messages received and processed at the MME1 30), the acceptance and processing of a modified content in at least one signaling received in the handover procedure, the modified content being changed in comparison to a content received in the default handover procedure by at least one of adding, amending and omitting of at least one parameter or at least one value comprised therein, at the sender side (i.e. messages sent from the MME1 30), skipping of at least one signaling being sent in the default handover procedure, and, at the receiver side (i.e. messages received and processed at the MME1 30), the acceptance of a skipping of at least one signaling being received in the default handover procedure, and using data being internally stored instead of the at least one skipped signaling.

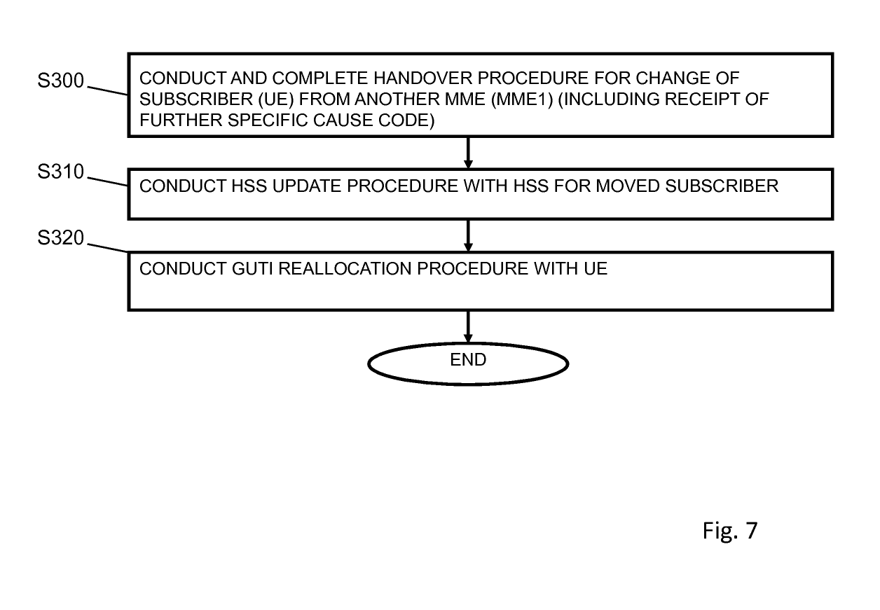

FIG. 7 shows a flowchart illustrating a processing executed in a mobility management entity being a target or new mobility management entity, like the MME2 40 of FIG. 1 according to some examples of embodiments of the invention.

In step S300, a handover procedure is executed for changing at least one subscriber attachment to a new mobility management entity while a current cell and tracking area of the at least one subscriber is kept unchanged. For example, according to some examples of embodiments of the invention, the handover procedure is conducted in accordance with the description related to step S50 of FIG. 1. Furthermore, according to some examples of embodiments of the invention, in the handover procedure, a specific cause code indicating that the handover procedure is due to a command from a core network element is received and processed.

According to some examples of embodiments, the handover procedure executed in S300 may comprise a determination of a type of a handover procedure to be continued as being a default handover procedure or a special handover procedure in which a change from a current mobility management entity to a new mobility management entity is to be executed while a current cell and tracking area of the at least one subscriber is kept unchanged. In case it is the special handover procedure, a configuration of the handover procedure to be executed may be modified from a default setting to a modified setting being different to the default setting. For example, the determination of the type of the handover procedure to be executed is based on an indication received in the handover procedure, for example by means of the specific cause code. Furthermore, the modified setting may comprises at least one of: at the sender side (i.e. messages sent from the MME2 40), a modification of a content of at least one signaling sent in the handover procedure by at least one of adding, amending and omitting of at least one parameter or at least one value comprised in a corresponding signaling sent in the default handover procedure, at the receiver side (i.e. messages received and processed at the MME2 40), the acceptance and processing of a modified content in at least one signaling received in the handover procedure, the modified content being changed in comparison to a content received in the default handover procedure by at least one of adding, amending and omitting of at least one parameter or at least one value comprised therein, at the sender side (i.e. messages sent from the MME2 40), skipping of at least one signaling being sent in the default handover procedure, and, at the receiver side (i.e. messages received and processed at the MME2 40), the acceptance of a skipping of at least one signaling being received in the default handover procedure, and using data being internally stored instead of the at least one skipped signaling.

It is to be noted that the target MME (MME2 40) may be set as the instance regarding a decision of keeping or changing the SGW (i.e. change from SGW1 50 to e.g. SGW2 55. For example, as the UE has not moved, the SGW may be kept. Nevertheless, according to some examples of embodiments, the final decision regarding conducting or not an additional further relocation of the SGW (i.e. to keep the SGW or to enable SGW relocation) may reside in the target MME. For example, this decision is based on further configuration settings, such as a coupling of the target MME with a specific SGW.

In step S310, when it is determined that the handover procedure is completed, an update procedure for the at least one subscriber with a home subscriber server of the at least one subscriber is conducted. For example, according to some examples of embodiments of the invention, an update location request message for informing the home subscriber server of the at least one subscriber about the change to the new mobility management entity is sent, and a corresponding update location acknowledgement message is received and processed for completing the update procedure. That is, according to some examples of embodiments of the invention, for example, the MME2 40 updates with the HSS 60 via an S6a Update Location Request and receives a response by means of an Update Location Answer.

In step S320, a reallocation procedure of a temporary identity of the at least one subscriber is conducted with the UE (UE 10) of the at least one subscriber. That is, according to some examples of embodiments of the invention, when the temporary identity is a GUTI, a GUTI reallocation command message is sent to the UE of the at least one subscriber for reallocating a GUTI and a TA list of the at least one subscriber, and a corresponding GUTI reallocation complete message is received and processed for completing the reallocation procedure.

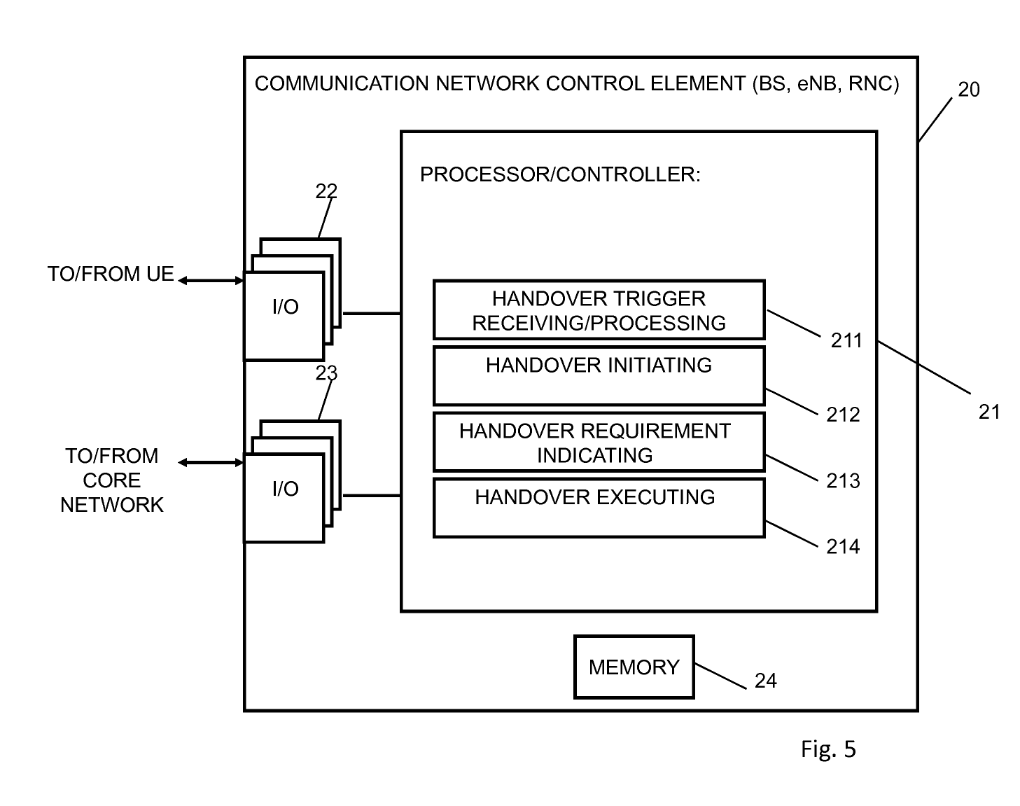

In FIG. 5, a block circuit diagram illustrating a configuration of a communication network control element, such as of the eNB 20, is shown, which is configured to implement the procedure for the MME changing procedure as described in connection with some of the examples of embodiments of the invention. It is to be noted that the communication network control element like the NodeB 20 shown in FIG. 5 may comprise several further elements or functions besides those described herein below, which are omitted herein for the sake of simplicity as they are not essential for understanding the invention. Furthermore, even though reference is made to a eNB, the communication network control element may be also another device having a similar function, such as a chipset, a chip, a module etc., which can also be part of a communication network control element or attached as a separate element to a communication network control element, or the like.

The communication network control element shown in FIG. 5 may comprise a processing function or processor 21, such as a CPU or the like, which executes instructions given by programs or the like related to the MME changing procedure. The processor 21 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference signs 22 and 23 denote transceiver or input/output (I/O) units (interfaces) connected to the processor 21. The I/O units 22 may be used for communicating with one or more communication elements like UEs. The I/O units 23 may be used for communicating with one or more core network control elements, like the MMEs 30 and 40. The I/O units 22 and 23 may be a combined unit comprising communication equipment towards several network elements, or may comprise a distributed structure with a plurality of different interfaces for different network elements. Reference sign 24 denotes a memory usable, for example, for storing data and programs to be executed by the processor 21 and/or as a working storage of the processor 21.

The processor 21 is configured to execute processing related to the above described MME changing procedure. In particular, the processor 21 comprises a sub-portion 211 as a processing portion which is usable for receiving and processing a handover trigger message. The portion 211 may be configured to perform processing according to step S100 of FIG. 3, for example. Furthermore, the processor 21 comprises a sub-portion 212 usable as a portion for initiating a handover to the same communication network control element. The portion 212 may be configured to perform processing according to step S110 of FIG. 3, for example. Furthermore, the processor 21 comprises a sub-portion 213 usable as a portion for indicating a handover requirement to the current MME. The portion 213 may be configured to perform a processing according to step S120 of FIG. 3, for example. In addition, the processor 21 comprises a sub-portion 214 usable as a portion for executing a handover procedure. The portion 214 may be configured to perform a processing according to step S130 of FIG. 3, for example.

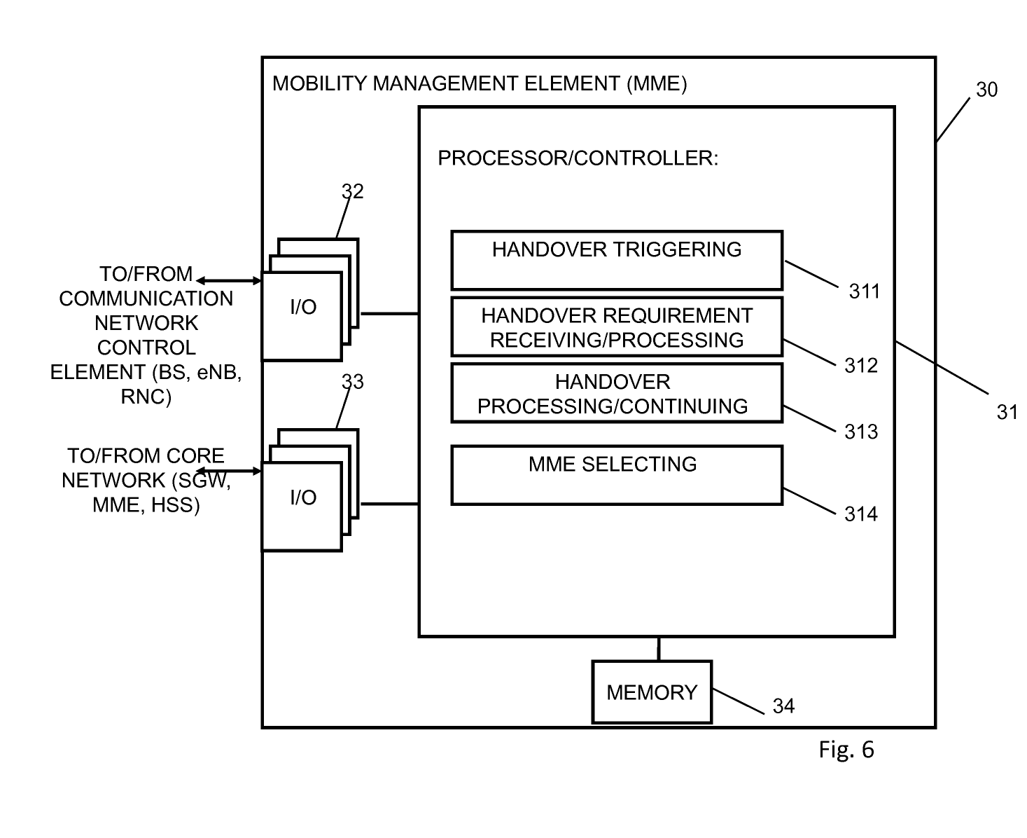

In FIG. 6, a block circuit diagram illustrating a configuration of a mobility management entity, such as of MME1 30, is shown, which is configured to implement the MME changing procedure as described in connection with some examples of embodiments of the invention. It is to be noted that the mobility management entity or MME1 30 shown in FIG. 6 may comprise several further elements or functions besides those described herein below, which are omitted herein for the sake of simplicity as they are not essential for understanding the invention. Furthermore, even though reference is made to a MME, the mobility management entity may be also another device having a similar function, such as a chipset, a chip, a module etc., which can also be part of a MME or attached as a separate element to a MME, or the like.

The mobility management entity or MME1 30 may comprise a processing function or processor 31, such as a CPU or the like, which executes instructions given by programs or the like related to the MME changing procedure. The processor 31 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference signs 32 and 33 denote transceiver or input/output (I/O) units (interfaces) connected to the processor 31. The I/O units 32 are used for communicating with one or more communication network control elements like the NodeB 20. The I/O units 33 are used for communicating with one or more core network like another MME. The I/O units 32 and 33 may be a combined unit comprising communication equipment towards several network elements, or may comprise a distributed structure with a plurality of different interfaces for different network elements. Reference sign 34 denotes a memory usable, for example, for storing data and programs to be executed by the processor 31 and/or as a working storage of the processor 31.

The processor 31 is configured to execute processing related to the above described MME changing procedure. In particular, the processor 31 comprises a sub-portion 311 as a processing portion which is usable for conducting a triggering of a handover. The portion 311 may be configured to perform processing according to step S210 of FIG. 4, for example. Furthermore, the processor 31 comprises a sub-portion 312 usable as a portion for receiving and processing a handover required message. The portion 312 may be configured to perform processing according to step S220 of FIG. 4, for example. Furthermore, the processor 31 comprises a sub-portion 313 usable as a portion for processing and continuing a handover. The portion 313 may be configured to perform a processing according to step S240 of FIG. 4, for example. In addition, the processor 31 comprises a sub-portion 314 usable as a portion for selecting a new MME. The portion 314 may be configured to perform a processing according to step S230 of FIG. 4, for example.

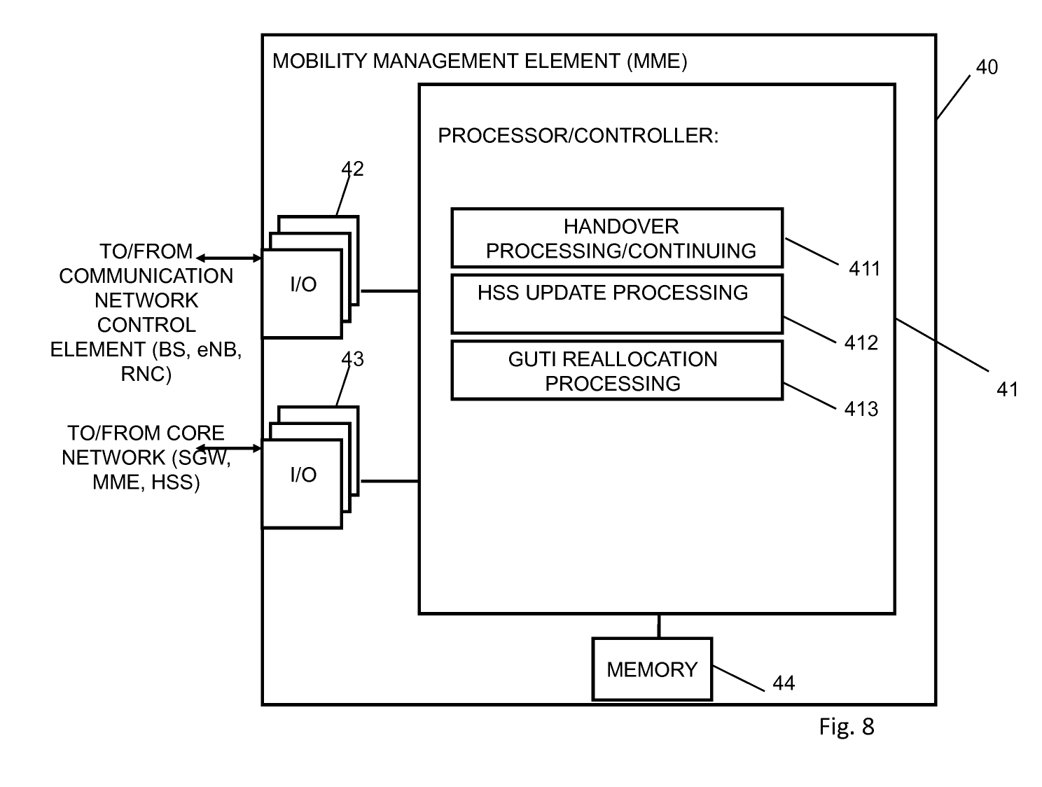

In FIG. 8, a block circuit diagram illustrating a configuration of a mobility management entity, such as of MME2 40, is shown, which is configured to implement the MME changing procedure as described in connection with some examples of embodiments of the invention. It is to be noted that the mobility management entity or MME2 40 shown in FIG. 8 may comprise several further elements or functions besides those described herein below, which are omitted herein for the sake of simplicity as they are not essential for understanding the invention. Furthermore, even though reference is made to a MME, the mobility management entity may be also another device having a similar function, such as a chipset, a chip, a module etc., which can also be part of a MME or attached as a separate element to a MME, or the like.

The mobility management entity or MME2 40 may comprise a processing function or processor 41, such as a CPU or the like, which executes instructions given by programs or the like related to the MME changing procedure. The processor 41 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference signs 42 and 43 denote transceiver or input/output (I/O) units (interfaces) connected to the processor 41. The I/O units 42 are used for communicating with one or more communication network control elements like the NodeB 20. The I/O units 43 are used for communicating with one or more core network like another MME or the HSS 60. The I/O units 42 and 43 may be a combined unit comprising communication equipment towards several network elements, or may comprise a distributed structure with a plurality of different interfaces for different network elements. Reference sign 44 denotes a memory usable, for example, for storing data and programs to be executed by the processor 41 and/or as a working storage of the processor 41.

The processor 41 is configured to execute processing related to the above described MME changing procedure. In particular, the processor 41 comprises a sub-portion 411 as a processing portion which is usable for conducting a handover procedure. The portion 411 may be configured to perform processing according to step S300 of FIG. 7, for example. Furthermore, the processor 41 comprises a sub-portion 412 usable as a portion for conducting a HSS update procedure. The portion 412 may be configured to perform processing according to step S310 of FIG. 7, for example. Furthermore, the processor 41 comprises a sub-portion 413 usable as a portion for conducting a temporary identity (e.g. GUTI) reallocation procedure. The portion 413 may be configured to perform a processing according to step S320 of FIG. 7, for example.

It is to be noted that while in the above described examples of embodiments of the invention the functions of the current (old) MME (MME1 30) and of the new MME (MME2 40) are described to be located in separate network elements, according to some further examples of embodiments of the invention, a network node acting as a mobility management entity (i.e. a MME) is configured to comprise functions and devices according to both the current (old) MME (MME1 30) and of the new MME (MME2 40). In other words, a mobility management entity according to some examples of embodiments of the invention is configured to become both a source and a target for the MME handover procedure as described above.

According to some further examples of embodiments of the invention, there is provided an apparatus comprising handover trigger receiving and processing means for receiving and processing a handover trigger message indicating that a change of at least one subscriber attachment from a current mobility management entity to a new mobility management entity is to be executed while a current cell and tracking area of the at least one subscriber is kept unchanged, handover initiating means for initiating a handover of a connection for the at least one subscriber from the current mobility management entity to a new mobility management entity while maintaining the current cell and tracking area of the at least one subscriber, and handover requirement indicating means for creating a handover required message and for causing a transmission of the handover required message to the current mobility management entity, the handover required message indicating a requirement of a relocation of the at least one subscriber to the current cell and tracking area.

In addition, according to some examples of embodiments of the invention, there is provided an apparatus comprising handover trigger means for creating a handover trigger message and for causing a transmission of the handover trigger message, the handover trigger message indicating that a change of at least one subscriber attachment from a current mobility management entity to a new mobility management entity is to be executed while a current cell and tracking area of the at least one subscriber is kept unchanged, handover required message processing means for receiving and processing a handover required message, the handover required message indicating a requirement of a relocation of the at least one subscriber to the current cell and tracking area, and handover processing means for continuing a handover procedure of a connection for the at least one subscriber from the current mobility management entity to a new mobility management entity.

Moreover, according to some examples of embodiments of the invention, there is provided an apparatus comprising handover means for executing a handover procedure for changing at least one subscriber attachment to a new mobility management entity while a current cell and tracking area of the at least one subscriber is kept unchanged, home subscriber server updating means for conducting an update procedure for the at least one subscriber with a home subscriber server of the at least one subscriber when the handover procedure is completed, and temporary identity reallocating means for conducting a reallocation procedure of a temporary identity of the at least one subscriber with a communication element of the at least one subscriber.

For the purpose of the present invention as described herein above, it should be noted that
an access technology via which signaling is transferred to and from a network element may be any technology by means of which a network element or sensor node can access another network element or node (e.g. via a base station or generally an access node). Any present or future technology, such as WLAN (Wireless Local Access Network), WiMAX (Worldwide Interoperability for Microwave Access), LTE, LTE-A, Bluetooth, Infrared, and the like may be used; although the above technologies are mostly wireless access technologies, e.g. in different radio spectra, access technology in the sense of the present invention implies also wired technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable communication networks, stations and transmission nodes may be or comprise any device, apparatus, unit or means by which a station, entity or other user equipment may connect to and/or utilize services offered by the access network; such services include, among others, data and/or (audio-) visual communication, data download etc.;
a user equipment or communication network element (station) may be any device, apparatus, unit or means by which a system user or subscriber may experience services from an access network, such as a mobile phone or smart phone, a personal digital assistant PDA, or computer, or a device having a corresponding functionality, such as a modem chipset, a chip, a module etc., which can also be part of a UE or attached as a separate element to a UE, or the like;
method steps likely to be implemented as software code portions and being run using a processor at a network element or terminal (as examples of devices, apparatuses and/or modules thereof, or as examples of entities including apparatuses and/or modules for it), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved; for example, for executing operations and functions according to examples of embodiments of the invention, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

As described above, there is provided a mechanism for executing a handover for a subscriber between mobility management entities for load balancing reasons. A current mobility management entity sends a handover trigger message to a communication network control element like an eNB for indicating a relocation to the current cell and tracking area of the subscriber. The eNB starts a handover procedure to itself and sends a handover required message to the current mobility measurement entity. The current mobility measurement entity continues a handover procedure of a connection for the at least one subscriber from the current mobility management entity to a new mobility management entity, wherein the new mobility management entity is selectable at the current mobility management entity. The handover procedure can be modified in comparison to a default handover procedure by modifying and/or omitting handover related signaling. After the handover is completed, the new mobility management entity initiates a location update at a home subscriber server and reallocates the subscriber's UE a new temporary identity and tracking area list.

Although the present invention has been described herein before with reference to particular embodiments thereof, the present invention is not limited thereto and various modifications can be made thereto.

1. An apparatus comprising
at least one processor, and
at least one memory for storing instructions to be executed by the processor, wherein
the at least one memory and the instructions are configured to, with the at least one processor, cause the apparatus at least to perform:
a handover trigger receiving and processing function configured to receive and process a handover trigger message indicating that a change of at least one subscriber attachment from a current mobility management entity to a new mobility management entity is to be executed while a current cell and tracking area of the at least one subscriber is kept unchanged,
a handover initiating function configured to initiate a handover of a connection for the at least one subscriber from the current mobility management entity to a new mobility management entity while maintaining the current cell and tracking area of the at least one subscriber, and
a handover requirement indicating function configured to create a handover required message and cause transmission of the handover required message to the current mobility management entity, the handover required message indicating a requirement of a relocation of the at least one subscriber to the current cell and tracking area.

2. The apparatus according to claim 1, wherein the handover trigger receiving and processing function is further configured to receive the handover trigger message from the current mobility management entity.

3. The apparatus according to claim 1, wherein the handover trigger message comprises a first specific cause code indicating that the change of the at least one subscriber attachment from the current mobility management entity is due to a load balancing process.

4. The apparatus according to claim 1, wherein the handover initiating function is further configured, for maintaining the cell and tracking area of the at least one subscriber, to start a handover procedure for the at least one subscriber to the same cell to which the subscriber is currently attached.

5. The apparatus according to claim 1, wherein the handover required message comprises a second specific cause code indicating that the requirement of the relocation of the at least one subscriber to the current cell and tracking area is due to a command from a core network element.

6. The apparatus according to claim 1, wherein the at least one memory and the instructions are further configured to, with the at least one processor, cause the apparatus at least to perform
a handover executing function configured to communicate with the current mobility management entity and a new mobility management entity for completing the handover of the connection for the at least one subscriber from the current mobility management entity to the new mobility management entity while maintaining the current cell and tracking area of the at least one subscriber by indicating the current cell and tracking area as a target cell and target tracking area of the handover.

7. The apparatus according to claim 6, wherein
the handover executing function is further configured to determine a type of a handover procedure to be executed being a default handover procedure or a special handover procedure in which a change from a current mobility management entity to a new mobility management entity is to be executed while a current cell and tracking area of the at least one subscriber is kept unchanged, wherein
when it is determined that the type of the handover procedure to be executed is the special handover procedure, the handover executing function is further configured to modify a configuration of the handover procedure to be executed from a default setting to a modified setting being different to the default setting.

8. The apparatus according to claim 7, wherein the determination of the type of the handover procedure to be conducted is based on an indication received in the handover trigger message.

9. The apparatus according to claim 7, wherein the handover executing function is further configured to modify the configuration of the handover procedure to be executed from the default setting to the modified setting by conducting at least one of:
modifying a content of at least one signaling sent in the handover procedure by at least one of adding, amending and omitting of at least one parameter or at least one value comprised in a corresponding signaling sent in the default handover procedure,
accepting and processing a modified content in at least one signaling received in the handover procedure, the modified content being changed in comparison to a content received in the default handover procedure by at least one of adding, amending and omitting of at least one parameter or at least one value comprised therein,
skipping at least one signaling being sent in the default handover procedure, and
accepting skipping of at least one signaling being received in the default handover procedure, and using data being internally stored instead of the at least one skipped signaling.

10. The apparatus according to claim 1, wherein the apparatus is comprised in a communication network control element comprising at least one of a base station, an access node or an evolved Node B of a cellular communication network, wherein the communication network control element is configured to control a communication with at least one of a terminal device or user equipment of the at least one subscriber.

11. A method comprising
receiving and processing a handover trigger message indicating that a change of at least one subscriber attachment from a current mobility management entity to a new mobility management entity is to be executed while a current cell and tracking area of the at least one subscriber is kept unchanged,
initiating a handover of a connection for the at least one subscriber from the current mobility management entity to a new mobility management entity while maintaining the current cell and tracking area of the at least one subscriber,
creating a handover required message for indicating a requirement of a relocation of the at least one subscriber to the current cell and tracking area, and
causing transmission of the handover required message to the current mobility management entity.

12. The method according to claim 11, further comprising receiving the handover trigger message from the current mobility management entity.

13. The method according to claim 11, wherein the handover trigger message comprises a first specific cause code indicating that the change of the at least one subscriber attachment from the current mobility management entity is due to a load balancing process.

14. The method according to claim 11, further comprising, for maintaining the current cell and tracking area of the at least one subscriber, starting a handover procedure for the at least one subscriber to the same cell to which the subscriber is currently attached.

15. The method according to claim 11, wherein the handover required message comprises a second specific cause code indicating that the requirement of the relocation of the at least one subscriber to the current cell and tracking area is due to a command from a core network element.

16. The method according to claim 11, further comprising
executing a handover procedure by communicating with the current mobility management entity and a new mobility management entity for completing the handover of the connection for the at least one subscriber from the current mobility management entity to the new mobility management entity while maintaining the current cell and tracking area of the at least one subscriber by indicating the current cell and tracking area as a target cell and target tracking area of the handover.

17. The method according to claim 16, further comprising
determining a type of a handover procedure to be executed being a default handover procedure or a special handover procedure in which a change from a current mobility management entity to a new mobility management entity is to be executed while a current cell and tracking area of the at least one subscriber is kept unchanged, and
when it is determined that the type of the handover procedure to be executed is the special handover procedure, modifying a configuration of the handover procedure to be executed from a default setting to a modified setting being different to the default setting.

18. The method according to claim 17, wherein the determination of the type of the handover procedure to be conducted is based on an indication received in the handover trigger message.

19. The method according to claim 17, wherein the modification of the configuration of the handover procedure to be executed from the default setting to the modified setting comprises at least one of:
modifying a content of at least one signaling sent in the handover procedure by at least one of adding, amending and omitting of at least one parameter or at least one value comprised in a corresponding signaling sent in the default handover procedure,
accepting and processing a modified content in at least one signaling received in the handover procedure, the modified content being changed in comparison to a content received in the default handover procedure by at least one of adding, amending and omitting of at least one parameter or at least one value comprised therein,
skipping at least one signaling being sent in the default handover procedure, and
accepting skipping of at least one signaling being received in the default handover procedure, and using data being internally stored instead of the at least one skipped signaling.

20. The method according to claim 11, wherein the method is implemented in a communication network control element comprising at least one of a base station, an access node or an evolved Node B of a cellular communication network, wherein the communication network control element is configured to control a communication with at least one of a terminal device or user equipment of the at least one subscriber.

21. An apparatus comprising
at least one processor, and
at least one memory for storing instructions to be executed by the processor, wherein
the at least one memory and the instructions are configured to, with the at least one processor, cause the apparatus at least to perform:
a handover trigger function configured to create a handover trigger message and to cause transmission of the handover trigger message, the handover trigger message indicating that a change of at least one subscriber attachment from a current mobility management entity to a new mobility management entity is to be executed while a current cell and tracking area of the at least one subscriber is kept unchanged,
a handover required message processing function configured to receive and process a handover required message, the handover required message indicating a requirement of a relocation of the at least one subscriber to the current cell and tracking area, and
a handover processing function configured to continue a handover procedure of a connection for the at least one subscriber from the current mobility management entity to a new mobility management entity.

22. The apparatus according to claim 21, wherein the handover trigger message comprises a first specific cause code indicating that the change of the at least one subscriber attachment from the current mobility management entity is due to a load balancing process.

23. The apparatus according to claim 21, wherein the at least one memory and the instructions are further configured to, with the at least one processor, cause the apparatus at least to perform
a handover command receiving and processing function configured to receive and process a command for initiating the change of at least one subscriber attachment from a current mobility management entity to a new mobility management entity from at least one of a network operator or an operation and maintenance element, wherein the handover trigger function is further configured to create and to cause transmission of the handover trigger message in reaction of a receipt of the command, wherein the command further comprises an indication of an identity of a mobility management entity to be used as the new mobility management entity.

24. The apparatus according to claim 21, wherein the at least one memory and the instructions are further configured to, with the at least one processor, cause the apparatus at least to perform
a selection function configured to select the new mobility management entity to which the handover of the connection for the at least one subscriber from the current mobility management entity is to be continued, wherein the handover processing function is further configured to continue the handover of the connection to the selected mobility management entity.

25. The apparatus according to claim 24, wherein the selection function is further configured to select the new mobility management entity on the basis of one of
an internal selection algorithm, and
an indication of an identity of a mobility management entity to be used as the new mobility management entity received from at least one of a network operator or an operation and maintenance element.

26. The apparatus according to claim 21, wherein the handover required message comprises a second specific cause code indicating that the requirement of the relocation of the at least one subscriber to the current cell and tracking area is due to a command from a core network element.

27. The apparatus according to claim 21, wherein the at least one memory and the instructions are further configured to, with the at least one processor, cause the apparatus at least to perform
a handover continuing function configured to communicate with a communication network control element to which the at least one subscriber is attached and the new mobility management entity for continuing the handover procedure of the connection for the at least one subscriber from the current mobility management entity to the new mobility management entity while maintaining the current cell and tracking are of the at least one subscriber by using the current cell and tracking area as a target cell and target tracking area of the handover.

28. The apparatus according to claim 27, wherein
the handover continuing function is further configured to determine a type of a handover procedure to be continued being a default handover procedure or a special handover procedure in which a change from a current mobility management entity to a new mobility management entity is to be executed while a current cell and tracking area of the at least one subscriber is kept unchanged, wherein
when it is determined that the type of the handover procedure to be continued is the special handover procedure, the handover continuing function is further configured to modify a configuration of the handover procedure to be continued from a default setting to a modified setting being different to the default setting.

29. The apparatus according to claim 28, wherein the determination of the type of the handover procedure to be continued is based on an indication received in the handover required message.

30. The apparatus according to claim 28, wherein the handover continuing function is further configured to modify the configuration of the handover procedure to be continued from the default setting to the modified setting by conducting at least one of:
modifying a content of at least one signaling sent in the handover procedure by at least one of adding, amending and omitting of at least one parameter or at least one value comprised in a corresponding signaling sent in the default handover procedure,
accepting and processing a modified content in at least one signaling received in the handover procedure, the modified content being changed in comparison to a content received in the default handover procedure by at least one of adding, amending and omitting of at least one parameter or at least one value comprised therein,
skipping at least one signaling being sent in the default handover procedure, and
accepting skipping of at least one signaling being received in the default handover procedure, and using data being internally stored instead of the at least one skipped signaling.

31. The apparatus according to claim 26, wherein the apparatus is comprised in a mobility management entity acting as the current mobility management entity, wherein the subscriber is attached to a cell controlled by a communication network control element comprising at least one of a base station, an access node or an evolved Node B of a cellular communication network, wherein the communication network control element is configured to control a communication with at least one of a terminal device or user equipment of the at least one subscriber.

32. A method comprising
creating a handover trigger message indicating that a change of at least one subscriber attachment from a current mobility management entity to a new mobility management entity is to be executed while a current cell and tracking area of the at least one subscriber is kept unchanged,
causing transmission of the handover trigger message,
receiving and processing a handover required message, the handover required message indicating a requirement of a relocation of the at least one subscriber to the current cell and tracking area, and
continuing a handover procedure of a connection for the at least one subscriber from the current mobility management entity to a new mobility management entity.

33. The method according to claim 32, wherein the handover trigger message comprises a first specific cause code indicating that the change of the at least one subscriber attachment from the current mobility management entity is due to a load balancing process.

34. The method according to claim 32, further comprising
receiving and processing a command for initiating the change of at least one subscriber attachment from a current mobility management entity to a new mobility management entity from at least one of a network operator or an operation and maintenance element, wherein the handover trigger message is created and transmitted in reaction of a receipt of the command, wherein the command further comprises an indication of an identity of a mobility management entity to be used as the new mobility management entity.

35. The method according to claim 32, further comprising
selecting the new mobility management entity to which the handover of the connection for the at least one subscriber from the current mobility management entity is to be continued, wherein the handover procedure of the connection is continued to the selected mobility management entity.

36. The method according to claim 35, wherein the new mobility management entity is selected on the basis of one of
an internal selection algorithm, and
an indication of an identity of a mobility management entity to be used as the new mobility management entity received from at least one of a network operator or an operation and maintenance element.

37. The method according to claim 32, wherein the handover required message comprises a second specific cause code indicating that the requirement of the relocation of the at least one subscriber attachment to the current cell and tracking area is due to a command from a core network element.

38. The method according to claim 32, further comprising
continuing a handover procedure by communicating with a communication network control element to which the at least one subscriber is attached and the new mobility management entity for continuing the handover of the connection for the at least one subscriber from the current mobility management entity to the new mobility management entity while maintaining the current cell and tracking area of the at least one subscriber by using the current cell and tracking area as a target cell and target tracking area of the handover.

39. The method according to claim 38, further comprising
determining a type of a handover procedure to be continued being a default handover procedure or a special handover procedure in which a change from a current mobility management entity to a new mobility management entity is to be executed while a current cell and tracking area of the at least one subscriber is kept unchanged, and
when it is determined that the type of the handover procedure to be continued is the special handover procedure, modifying a configuration of the handover procedure to be continued from a default setting to a modified setting being different to the default setting.

40. The method according to claim 39, wherein the determination of the type of the handover procedure to be continued is based on an indication received in the handover required message.

41. The method according to claim 39, wherein the modification of the configuration of the handover procedure to be continued from the default setting to the modified setting comprises at least one of:
modifying a content of at least one signaling sent in the handover procedure by at least one of adding, amending and omitting of at least one parameter or at least one value comprised in a corresponding signaling sent in the default handover procedure,
accepting and processing a modified content in at least one signaling received in the handover procedure, the modified content being changed in comparison to a content received in the default handover procedure by at least one of adding, amending and omitting of at least one parameter or at least one value comprised therein,
skipping at least one signaling being sent in the default handover procedure, and
accepting skipping of at least one signaling being received in the default handover procedure, and using data being internally stored instead of the at least one skipped signaling.

42. The method according to claim 32, wherein the method is implemented in a mobility management entity acting as the current mobility management entity, wherein the subscriber is attached to a cell controlled by a communication network control element comprising at least one of a base station, an access node or an evolved Node B of a cellular communication network, wherein the communication network control element is configured to control a communication with at least one of a terminal device or user equipment of the at least one subscriber.

43. An apparatus comprising
at least one processor, and
at least one memory for storing instructions to be executed by the processor, wherein
the at least one memory and the instructions are configured to, with the at least one processor, cause the apparatus at least to perform:
a handover function configured to execute a handover procedure for changing at least one subscriber attachment to a new mobility management entity while a current cell and tracking area of the at least one subscriber is kept unchanged,
a home subscriber server updating function configured to conduct an update procedure for the at least one subscriber with a home subscriber server of the at least one subscriber when the handover procedure is completed, and
a temporary identity reallocating function configured to conduct a reallocation procedure of a temporary identity of the at least one subscriber with a communication element of the at least one subscriber.

44. The apparatus according to claim 43, wherein the handover function is further configured to receive and process a second specific cause code indicating that the handover procedure is due to a command from a core network element.

45. The apparatus according to claim 43, wherein the home subscriber server updating function is further configured to cause transmission of an update location request message for informing the home subscriber server of the at least one subscriber about the change to the new mobility management entity, and
to receive and process an update location acknowledgement message for completing the update procedure.

46. The apparatus according to claim 43, wherein the temporary identity is a global unique temporary identity, and
the temporary identity reallocating function is further configured to
cause transmission of a global unique temporary identity reallocation command message to the communication element of the at least one subscriber for reallocating a global unique temporary identity and a tracking area list of the at least one subscriber, and
to receive and process a global unique temporary identity reallocation complete message for completing the reallocation procedure.

47. The apparatus according to claim 43, wherein
the handover function is further configured to determine a type of a handover procedure to be executed being a default handover procedure or a special handover procedure in which a change from a current mobility management entity to a new mobility management entity is to be executed while a current cell and tracking area of the at least one subscriber is kept unchanged, wherein
when it is determined that the type of the handover procedure to be executed is the special handover procedure, the handover function is further configured to modify a configuration of the handover procedure to be executed from a default setting to a modified setting being different to the default setting.

48. The apparatus according to claim 47, wherein the determination of the type of the handover procedure to be executed is based on an indication received in the handover procedure.

49. The apparatus according to claim 47, wherein the handover function is further configured to modify the configuration of the handover procedure to be executed from the default setting to the modified setting by conducting at least one of:
modifying a content of at least one signaling sent in the handover procedure by at least one of adding, amending and omitting of at least one parameter or at least one value comprised in a corresponding signaling sent in the default handover procedure,
accepting and processing a modified content in at least one signaling received in the handover procedure, the modified content being changed in comparison to a content received in the default handover procedure by at least one of adding, amending and omitting of at least one parameter or at least one value comprised therein,
skipping at least one signaling being sent in the default handover procedure, and
accepting skipping of at least one signaling being received in the default handover procedure, and using data being internally stored instead of the at least one skipped signaling.

50. The apparatus according to claim 43, wherein the apparatus is comprised in a mobility management entity acting as the new mobility management entity, wherein the subscriber is attached to a cell controlled by a communication network control element comprising at least one of a base station, an access node or an evolved Node B of a cellular communication network, wherein the communication network control element is configured to control a communication with at least one of a terminal device or user equipment of the at least one subscriber.

51. A method comprising
executing a handover procedure for changing at least one subscriber attachment to a new mobility management entity while a current cell and tracking area of the at least one subscriber is kept unchanged,
conducting an update procedure for the at least one subscriber with a home subscriber server of the at least one subscriber when the handover procedure is completed, and
conducting a reallocation procedure of a temporary identity of the at least one subscriber with a communication element of the at least one subscriber.

52. The method according to claim 51, further comprising, when conducting the handover procedure, receiving and processing a second specific cause code indicating that the handover procedure is due to a command from a core network element.

53. The method according to claim 51, further comprising
causing transmission of an update location request message for informing the home subscriber server of the at least one subscriber about the change to the new mobility management entity, and
receiving and processing an update location acknowledgement message for completing the update procedure.

54. The method according to claim 51, wherein the temporary identity is a global unique temporary identity, the method further comprising
causing transmission of a global unique temporary identity reallocation command message to the communication element of the at least one subscriber for reallocating a global unique temporary identity and a tracking area list of the at least one subscriber, and
receiving and processing a global unique temporary identity reallocation complete message for completing the reallocation procedure.

55. The method according to claim 51, further comprising
determining a type of a handover procedure to be executed being a default handover procedure or a special handover procedure in which a change from a current mobility management entity to a new mobility management entity is to be executed while a current cell and tracking area of the at least one subscriber is kept unchanged, and
when it is determined that the type of the handover procedure to be executed is the special handover procedure, modifying a configuration of the handover procedure to be executed from a default setting to a modified setting being different to the default setting.

56. The method according to claim 55, wherein the determination of the type of the handover procedure to be executed is based on an indication received in the handover procedure.

57. The method according to claim 55, wherein the modification of the configuration of the handover procedure to be executed from the default setting to the modified setting comprises at least one of:
modifying a content of at least one signaling sent in the handover procedure by at least one of adding, amending and omitting of at least one parameter or at least one value comprised in a corresponding signaling sent in the default handover procedure,
accepting and processing a modified content in at least one signaling received in the handover procedure, the modified content being changed in comparison to a content received in the default handover procedure by at least one of adding, amending and omitting of at least one parameter or at least one value comprised therein,
skipping at least one signaling being sent in the default handover procedure, and
accepting skipping of at least one signaling being received in the default handover procedure, and using data being internally stored instead of the at least one skipped signaling.

58. The method according to claim 51, wherein the method is implemented in a mobility management entity acting as the new mobility management entity, wherein the subscriber is attached to a cell controlled by a communication network control element comprising at least one of a base station, an access node or an evolved Node B of a cellular communication network, wherein the communication network control element is configured to control a communication with at least one of a terminal device or user equipment of the at least one subscriber.

59. A computer program embodied on a non-transitory computer-readable medium, comprising software code portions for performing the steps of claim 11 when said product is run on a computer.

60. The computer program product according to claim 59, wherein
the computer program product is directly loadable into the internal memory of the computer or transmittable via a network by means of at least one of upload, download and push procedures.

61. An apparatus comprising
at least one processor,
at least one interface to at least one other network element, and
at least one memory for storing instructions to be executed by the processor, wherein
the at least one memory and the instructions are configured to, with the at least one processor, cause the apparatus at least to perform:
a method according to claim 32, and
executing a handover procedure for changing at least one subscriber attachment to a new mobility management entity while a current cell and tracking area of the at least one subscriber is kept unchanged,
conducting an update procedure for the at least one subscriber with a home subscriber server of the at least one subscriber when the handover procedure is completed, and
conducting a reallocation procedure of a temporary identity of the at least one subscriber with a communication element of the at least one subscriber.

62. A computer program embodied on a non-transitory computer-readable medium, comprising software code portions for performing the steps of claim 32 when said product is run on a computer.

63. A computer program embodied on a non-transitory computer-readable medium, comprising software code portions for performing the steps of claim 51 when said product is run on a computer.
